(19) United States
(12) Patent Application Publication
(10) Pub. No.: US 2013/0151952 A1
(43) Pub. Date: Jun. 13, 2013

(54) DISPLAY PROCESSING DEVICE, CONTROL PROGRAM, AND COMPUTER-READABLE RECORDING MEDIUM STORING THE CONTROL PROGRAM

(71) Applicants: Takashi Yamamoto, Osaka-shi (JP); Jiro Kiyama, Osaka-shi (JP)

(72) Inventors: Takashi Yamamoto, Osaka-shi (JP); Jiro Kiyama, Osaka-shi (JP)

(21) Appl. No.: 13/498,959

(22) PCT Filed: Dec. 28, 2010
(86) PCT No.: PCT/JP2010/073706

§ 371 Date: Mar. 29, 2012

(30) Foreign Application Priority Data
Dec. 29, 2009 (JP) 2009-299205

(51) Int. Cl. G06F 17/21

(52) U.S. Cl. CPC G06F 17/21
USPC 715/243

(57) ABSTRACT

The content display processing device (1a) includes a display control section (133a) configured to control a display section to display, on a display area of the display section, character string data which is selected out of text data by a display target range which moves in order of characters contained in the text data, and the character string data is displayed in accordance with the move of the display target range. The display control section (133a) sets, in the display area, a display avoidance area (Rb) in which the character string data is not displayed.

### TECHNICAL FIELD

The present invention relates to a display processing device, and the like, which causes a display device to simultaneously display a plural kinds of contents.

### BACKGROUND ART

In recent years, in accordance with diversification of contents such as a document, images such as a video and a photograph, and an Internet website, display processing devices capable of causing a display device to simultaneously display a plurality of contents of such kinds have become popular. Examples of such a display processing device encompass a PC (Personal Computer) and a PDA (Personal Digital Assistance).

With regard to such a display processing device, in a case where, for example, two kinds of contents are displayed in one (1) display area of a display device, the display area has conventionally been, in general, divided lengthwise or crosswise into two areas so that (i) one of the two kinds of contents is displayed in one of the two areas and (ii) the other of the two kinds of contents is displayed in the other of the two areas.

Under the circumstances, in recent years, a technique has been proposed in which a plurality of contents are simultaneously displayed by effectively utilizing an entire display area. In the technique, an image or a video is displayed in a rectangular area, which is a part of the display area, and the other content(s) is(are) displayed in a non-rectangular area, which is the rest part of the display area.

Patent Literature 1 discloses a technique to simultaneously display (i) document data which is typed in by using a word processing function and (ii) video data. Specifically, the document data and the video data are simultaneously displayed by any of the following three methods: (1) the document data is displayed in the entire display area, and the video data is displayed partially over the document data, (2) the video data is displayed in a part of the display area, and the document data is displayed in the entire display area over the video data, and (3) the video data is displayed in a part of the display area, and the document data is displayed in a rectangular area in which the video data is not displayed.

Non Patent Literature 1 discloses technique, in the section “15 Alignment, font styles, and horizontal rules”, that, when non-document data (e.g., video data, image data, or Java (registered trademark) apple) and document data are simultaneously displayed, document data is displayed so as to encompass a rectangular area in which the non-document data is displayed (that is, the document data is displayed in a non-rectangular area encompassing the rectangular area).

### CITATION LIST

### Patent Literature

### [Patent Literature 1]

Japanese Patent Application Publication Tokukaihei NO. 8-287270 A (Publication date: Nov. 1, 1996)

### Non Patent Literature

### [Non Patent Literature 1]

“Html 4.01 Specification”, W3C Recommendation (Dec. 24, 1999), http://www.w3.org/TR/HTML401/(reference date: Dec. 7, 2009)

### SUMMARY OF INVENTION

### Technical Problem

However, the technique disclosed in Patent Literature 1 does not give consideration to viewing existing document data that is read in to be viewed. That is, Patent Literature 1 is silent about a configuration for scrolling a document displayed in the display area in order for a user to go on reading the document. Therefore, in a case of scrolling existing document data which is displayed simultaneously with video data, the technique disclosed in Patent Literature 1 cannot display the document data and the video data such that both the document data and the video data is easily viewable.

Specifically, in the method (1), the document data is partially hidden behind the video data. Therefore, the hidden part of the document data cannot be viewed. Even if the document data could be scrolled, the same problem still occurs. In the method (2), it is difficult to view the video because document data is displayed over the video data. In the method (3), the document data is displayed in a reduced area. Therefore, the method (3) is not user friendly, because an amount of document data viewable at a time is limited. Even if the document data could be scrolled, the same problem still occurs.

In the technique disclosed in Non Patent Literature 1, (i) non-document data and document data do not overlap each other and (ii) the document data is displayed in an area larger than that in the method (3). Therefore, both the document data and the non-document data can be viewed more easily. However, the non-document data is inserted into a fixed location in the document data, and accordingly, when the document data is scrolled, the video data will be scrolled together. Therefore, even if the technique disclosed in Non Patent Literature 1 is employed, both the document data and the non-document data cannot be constantly viewed easily.

The present invention is accomplished in view of the problem, and an object of the present invention is to provide a display processing device, and the like, which causes document data to be scrollably displayed in a non-rectangular area.

### Solution to Problem

In order to attain the object, a display processing device of the present invention includes a display control section configured to control a display section to display, on a display area of the display section, character string data which is selected out of text data by a display target range which moves in order of characters contained in the text data, the character string data being displayed in accordance with the move of the display target range, and the display control section setting, in the display area, a display avoidance area in which the character string data is not displayed.

Moreover, a method of the present invention for controlling a display processing device includes the step of: (a) causing a display area of a display section to display character string data which is selected out of text data by a display target range which moves in order of characters contained in the text data, the step (a) including causing the display section to display in the display area the character string data in accordance with the move of the display target range, and causing the display section to set in the display area a display avoidance area in which the character string data is not displayed.

According to the configuration, it is possible to cause the display area of the display section to display the character string data which is selected by the display target range which moves in the order of the characters contained in the text data (such that the text data is scrolled). Moreover, the display section is caused to set, in the display area, the display avoidance area in which the character string data is not displayed.

With the configuration, the character string data is displayed in an area in the display area other than the display avoidance area. That is, the text data can be scrollably displayed in the area (non-rectangular shaped area) in the display area other than the display avoidance area.

For example, in a case where non-text data (e.g., video data) is displayed in the display avoidance area simultaneously with text data being displayed in the area other than the display avoidance area, the configuration of the present invention allows the user to go on reading the text data by scrolling the text data while viewing the non-text data.

This brings about an effect of improving convenience of the user who continues reading the text data by scrolling the text data.

In order to attain the object, a display processing device of the present invention includes: a display control section configured to control a display section to display, on a display area of the display section, an object sequence which is selected out of object sequence data by a display target range which moves in order of a plurality of objects contained in the object sequence data, the object sequence being displayed in accordance with the move of the display target range, and the display control section setting, in the display area, a display avoidance area in which the object sequence, which is selected by the display target range, is not displayed.

Moreover, a method of the present invention for controlling a display processing device includes the step of: (a) causing a display area of a display section to display an object sequence which is selected out of object sequence data by a display target range which moves in order of a plurality of objects contained in the object sequence data, the step (a) including causing the display section to display in the display area the object sequence in accordance with the move of the display target range, and causing the display section to set in the display area a display avoidance area in which the object sequence is not displayed.

According to the configuration, the display area of the display section can be controlled to display the object sequence, which is selected by the display target range which is moved in the predetermined order of the plurality of objects constituting the object sequence data (such that the object sequence data is scrolled). Moreover, the display area has the display avoidance area in which the object sequence, which is selected by the display target range, is not displayed.

With the configuration, the object sequence, which is selected by the display target range, is displayed in an area in the display area other than the display avoidance area. That is, the object sequence data can be scrollably displayed in the area (non-rectangular shaped area) in the display area other than the display avoidance area.

For example, in a case where data (e.g., video data), which is different from the object sequence data, is displayed in the display avoidance area simultaneously with text data (as the object sequence data) being displayed in the area other than the display avoidance area, the configuration of the present invention allows the user to go on reading the text data by scrolling the text data while viewing the video data.

This brings about an effect of improving convenience of the user who continues viewing the object sequence data by scrolling the object sequence data.

### Advantageous Effects of Invention

As above described, the display processing device of the present invention includes a display control section configured to control a display section to display, on a display area of the display section, character string data which is selected out of text data by a display target range which moves in order of characters contained in the text data, the character string data being displayed in accordance with the move of the display target range, and the display control section setting, in the display area, a display avoidance area in which the character string data is not displayed.

Moreover, the method of the present invention for controlling the display processing device includes the step of: (a) causing a display area of a display section to display character string data which is selected out of text data by a display target range which moves in order of characters contained in the text data, the step (a) including causing the display section to display in the display area the character string data in accordance with the move of the display target range, and causing the display section to set in the display area a display avoidance area in which the character string data is not displayed.

With the configuration, the character string data is displayed in an area in the display area other than the display avoidance area. That is, the text data can be scrollably displayed in the area (non-rectangular shaped area) in the display area other than the display avoidance area.

This brings about an effect of improving convenience of the user who continues reading the text data by scrolling the text data.

The display processing device of the present invention includes: a display control section configured to control a display section to display, on a display area of the display section, an object sequence which is selected out of object sequence data by a display target range which moves in order of a plurality of objects contained in the object sequence data, the object sequence being displayed in accordance with the move of the display target range, and the display control section setting, in the display area, a display avoidance area in which the object sequence, which is selected by the display target range, is not displayed.

Moreover, the method of the present invention for controlling the display processing device includes the step of: (a) causing a display area of a display section to display an object sequence which is selected out of object sequence data by a display target range which moves in order of a plurality of objects contained in the object sequence data, the step (a) including causing the display section to display in the display area the object sequence in accordance with the move of the display target range, and causing the display section to set in the display area a display avoidance area in which the object sequence is not displayed.

With the configuration, the object sequence, which is selected by the display target range, is displayed in an area in the display area other than the display avoidance area. That is, the object sequence data can be scrollably displayed in the area (non-rectangular shaped area) in the display area other than the display avoidance area.

This brings about an effect of improving convenience of the user who continues viewing the object sequence data by scrolling the object sequence data.

For a fuller understanding of other objects, the nature, and advantages of the invention, reference should be made to the ensuing detailed description taken in conjunction with the accompanying drawings.

### BRIEF DESCRIPTION OF DRAWINGS

FIG. 1 is a block diagram illustrating a configuration of a content display processing device in accordance with Embodiment 1 of the present invention.

FIG. 2 is a view schematically illustrating processes carried out in the content display processing device shown in FIG. 1. (a) of FIG. 2 is a schematic view illustrating an example of electronic book data obtained by the content display processing device shown in FIG. 1. (b) of FIG. 2 is a schematic view illustrating an example of video data which is to be combined with the electronic book data in a combining process in the content display processing device shown in FIG. 1. (c) of FIG. 2 is a schematic view illustrating a state where the electronic book data shown in (a) of FIG. 2 is combined with the video data shown in (b) of FIG. 2 in the content display processing device shown in FIG. 1. (d) of FIG. 2 is a schematic view illustrating a state after the electronic book data is scrolled from the state shown in (c) of FIG. 2.

FIG. 3 is a flowchart illustrating how processes are carried out in the content display processing device shown in FIG. 1.

FIG. 4 is a view illustrating examples of data transmitted or received by sections of the content display processing device shown in FIG. 1. (a) of FIG. 4 is a schematic view illustrating an example of electronic book data. (b) of FIG. 4 is a schematic view illustrating an example of partial book data, (c) of FIG. 4 is a schematic view illustrating an example of display avoidance area information, (d) of FIG. 4 is a schematic view illustrating an example of partial book data into which an image object is inserted. (e) of FIG. 4 is a schematic view illustrating an example of data generated by a screen data creating section based on the partial book data shown in (d) of FIG. 4. (f) of FIG. 4 is a schematic view illustrating an example of combined data generated by providing video data into a non-object-sequence area in screen data supplied from the screen data creating section.

FIG. 5 is a flowchart illustrating how a display process of FIG. 3 is carried out.

FIG. 6 is a flowchart illustrating how a partial book data processing of FIG. 3 is carried out.

FIG. 7 is a flowchart illustrating how a combined data generating process of FIG. 3 is carried out.

(a) of FIG. 8 is a schematic view illustrating a relation between a non-object-sequence area and a display avoidance area. (b) of FIG. 8 is a schematic view illustrating a state where the display avoidance area is changed due to existence of characters having a large font size.

FIG. 9

(a) of FIG. 9 is a schematic view of scrolling of the electronic book and illustrates how characters of electronic book data scrolled are displayed when the electronic book data is scrolled without restriction of scroll amount. (b) of FIG. 9 is a schematic view of scrolling of the electronic book and illustrates how characters of electronic book data scrolled are displayed when the electronic book data is scrolled with restriction of scroll amount.

FIG. 10

(a) and (b) of FIG. 10 are schematic views illustrating modifications of (a) and (b) of FIG. 9, respectively. In the modifications, the display avoidance area is located on lower right in the display area.

FIG. 11 is a block diagram illustrating a configuration of a content display processing device in accordance with Embodiment 2 of the present invention.

FIG. 12 is a flowchart illustrating how a display process is carried out by the content display processing device shown in FIG. 11.

FIG. 13 is a view illustrating examples of data transmitted or received by sections of the content display processing device shown in FIG. 11. (a) of FIG. 13 is a schematic view illustrating an example of electronic book data. (b) of FIG. 13 is a schematic view illustrating an example of data which is obtained by decoding and analyzing the data shown in (a) of FIG. 13.

FIG. 14 is a flowchart illustrating how a screen data generating process of FIG. 12 is carried out.

FIG. 15 is a schematic view illustrating exemplary scrolling carried out by a content display processing device in accordance with Embodiment 3 of the present invention, and illustrates an example of how objects are displayed in a case where object sequence data, which is made up of only objects such as an image, is scrolled with restriction of scroll amount.

FIG. 16 is a schematic view illustrating an example of exemplary text data scrolling carried out by a content display processing device in accordance with Embodiment 4 of the present invention and illustrates an example of how a size and a display position of an object (such as an image) inserted in text data are adjusted when the text data is scrolled.

FIG. 17 is a schematic view illustrating exemplary text data scrolling carried out by the content display processing device in accordance with Embodiment 4 of the present invention and illustrates another example of how a size and a display position of an object (such as an image) inserted in text data are adjusted, when the text data is scrolled.

FIG. 18 is a schematic view illustrating exemplary text data scrolling carried out by the content display processing device in accordance with Embodiment 4 of the present invention and illustrates an example of a state where an object (such as an image) inserted in text data is kept displayed before and after the scrolling of the text data.

FIG. 19 is a schematic view illustrating exemplary text data scrolling carried out by the content display processing device in accordance with Embodiment 4 of the present invention, and illustrates an example of a state where an object (such as an image), which is inserted in text data but has not been displayed, appears after the text data is scrolled.

FIG. 20 is a schematic view illustrating exemplary text data scrolling carried out by the content display processing device in accordance with Embodiment 4 of the present invention, and illustrates an example of a state where an object (such as an image), which is inserted in text data and has been displayed, disappears after the text data is scrolled.

FIG. 21 is a schematic view illustrating exemplary text data scrolling carried out by a content display processing device in accordance with Embodiment 5 of the present invention and illustrates how characters are displayed, when text data of English sentence (alphabetic characters) is scrolled with restriction of scroll amount.

### DESCRIPTION OF EMBODIMENTS

A content display processing device (display processing device) 1 of the present invention is embodied as a device which causes a display area of a display device such as an CRT (Cathode-Ray Tube) to simultaneously display (i) text data containing a plurality of characters arranged in a predetermined order and (ii) a content which is different from the text data (hereinafter, such content is referred to as “non-text data”).

In this case, the content display processing device 1 carries out a process to cause the display area to display, in accordance with move of a display target range, character string data which is selected out of text data by the display target range which moves (such that the text data is scrolled) in the order of the characters contained in the text data. Here, an area (hereinafter, referred to as “display avoidance area Rb”), in which non-text data is displayed but the character string data is not displayed, is provided in the display area. This is a main characteristic feature of the present invention. In other words, the main characteristic feature is to scrollably display, in the display area, the character string data selected out of the text data, while the character string data is caused not to be displayed in the display avoidance area Rb, which remains in the display area.

Data, which is handled by the content display processing device 1 of the present invention, is not limited to the text data containing the plurality of characters arranged in the predetermined order. That is, the content display processing device 1 may cause the display area of the display device to simultaneously display (i) data (hereinafter, referred to as “object sequence data”) containing a plurality of objects arranged in a predetermined order and (ii) data (hereinafter, referred to as “non-object-sequence data”) which is different from the object sequence data.

In such a case, the content display processing device 1 carries out a process to cause the display area to display, in the predetermined order, an object sequence which is a group of the plurality of objects contained in the object sequence data. More specifically, the content display processing device 1 causes the display area to display, in accordance with move of a display target range, an object sequence selected out of the object sequence data by the display target range which moves (such that the object sequence data is scrolled) in the predetermined order of the plurality of objects contained in the object sequence data. In this case, a display avoidance area Rb, in which the non-object-sequence data is displayed but the selected object sequence is not displayed, is provided in the display area, and the object sequence selected out of the object sequence data is scrollably displayed in the display area in such a manner that the object sequence avoids the display avoidance area Rb which remains in the display area. This is a main characteristic feature of the present invention.

Note that the term “object” is used as a collective term for a character and an image. Therefore, the object sequence data may be (i) data containing only characters (i.e., text data), (ii) data containing only images, or (iii) data containing a character and an image. Note that the image is not limited to a particular kind of image, and therefore may be a thumbnail image, or the like.

Note that, in this specification, it is assumed that the object sequence data is structured data whose structure is determined by a tag. Examples of the object sequence data encompass (i) electronic book data described in XML (extended Markup Language) and (ii) a web page described in HTML (HyperText Markup Language). Note that, in the descriptions below, the object sequence data is assumed to be electronic book data for displaying an electronic book.

The non-object-sequence data is not limited to a particular kind of data, and any kinds of data such as a still image, a moving image, and a static text may be used as the non-object-sequence data. In the descriptions below, the non-object-sequence data is assumed to be a moving image (hereinafter, referred to as “video data M”). Note that the video data M may be, for example, (i) television (hereinafter, abbreviated as “TV”) video received from a broadcasting station, (ii) stream data obtained from an external server device via a communication network, or (iii) a video read out from a storage medium such as a Blu-ray Disc (registered trademark). In the descriptions below, the video data M is assumed to be a TV video.

The content display processing device 1 can be an information processing device such as a PC, a PDA, or a game machine. Note, however, that the content display processing device 1 is not limited to these.

In this specification, the content display processing device 1 is configured (i) to combine the object sequence data with the non-object-sequence data and (ii) to supply thus combined data to the display device. Note, however, that a destination to which the combined data is supplied is not limited to the display device. For example, the combined data (i) may be stored in a storage medium connected with the content display processing device 1 or (ii) may be sent to an external device via a communication network.

Note that the term “content display processing device 1” is used as a collective term for a content display processing device (display processing device) 1a and a content display processing device (display processing device) 1b (each of which will be later described).

The descriptions below discuss Embodiment 1 and Embodiment 2 in which electronic book data (i.e., object sequence data) is made up of characters of a Japanese sentence.

After that, Embodiment 3 will be discussed in which the object sequence data is made up of objects such as images. Subsequently, Embodiment 4 will be discussed in which the electronic book data (i.e., object sequence data) is text data of a Japanese sentence in which an object such as an image is inserted between characters.

Lastly, Embodiment 5 will be discussed in which the electronic book data (i.e., object sequence data) is text data made up of alphabetic characters of an English sentence.

### Embodiment 1

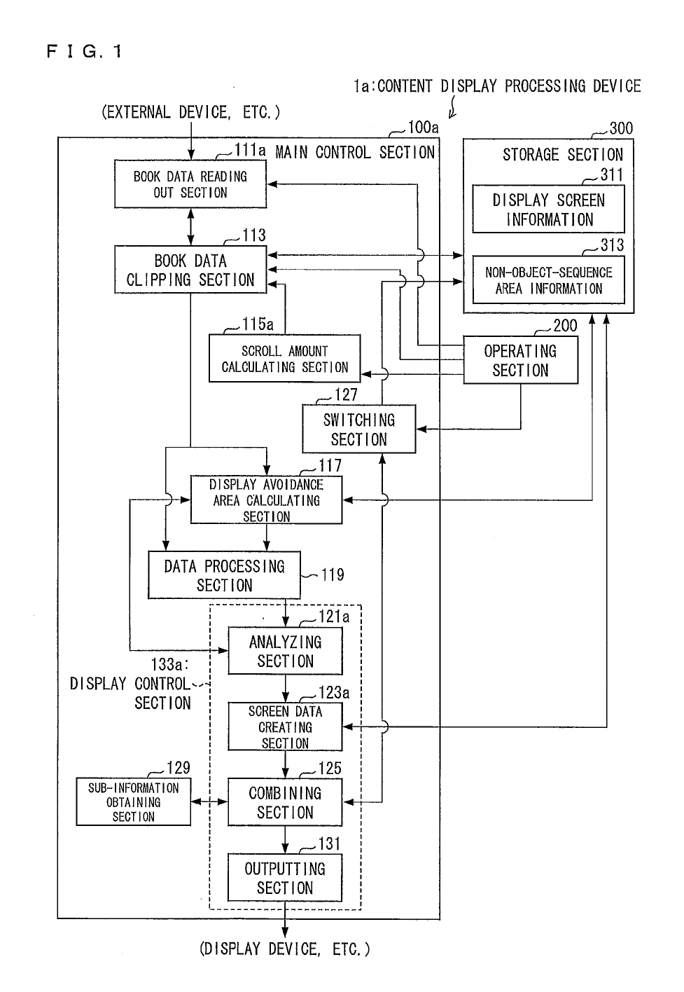

The following description discusses an embodiment of the present invention, with reference to FIGS. 1 through 9.

(Outline of Processes in Content Display Processing Device)

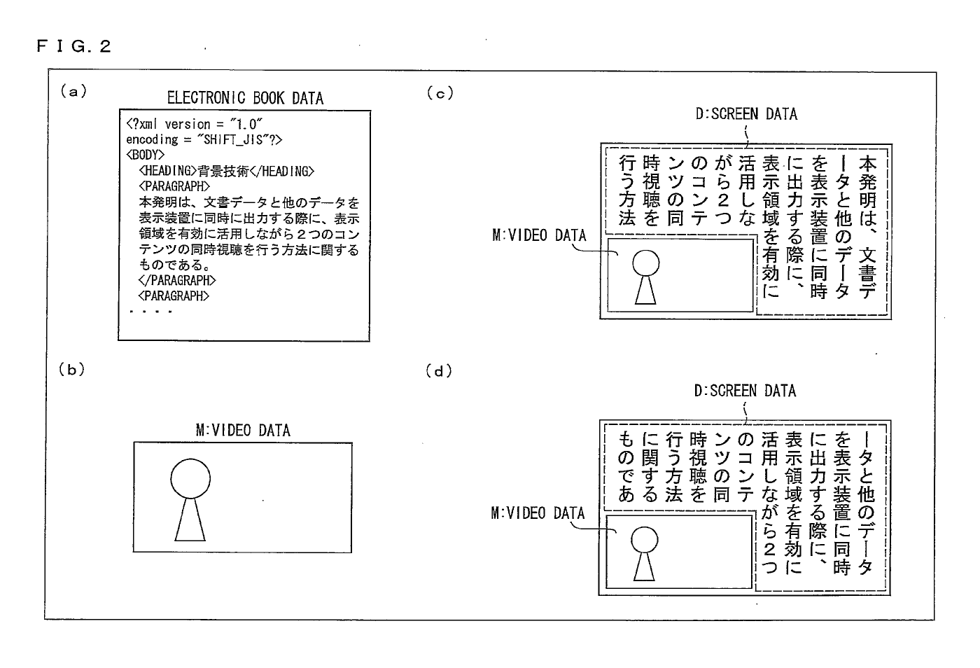

The following describes, with reference to FIG. 2, how a display process is carried out in a content display processing device 1a of the present embodiment. FIG. 2 is a schematic view illustrating how a display process is carried out in the content display processing device 1a.

First, the content display processing device 1a obtains electronic book data, and a screen data creating section 123a (later described) generates screen data (hereinafter, referred to as “screen data D”) which is used to display a part of the electronic book data in an area, in a display area, other than a display avoidance area Rb. Note that the content display processing device 1 obtains, for example, electronic book data illustrated in (a) of FIG. 2.

Then, in the content display processing device 1a, a combining section 125 (later described) generates combined data by combining (i) the screen data generated by the screen data creating section 123a and (ii) the video data M, in such a manner that the video data M is provided into the display avoidance area Rb. For example, in a case where the video data M is an image shown in (b) of FIG. 2, the content display processing device 1 combines the screen data D with the video data M as illustrated in (c) of FIG. 2.

Then, every time the content display processing device 1 receives an instruction on renewing the display of the electronic book data (specifically, the display of the electronic book data is scrolled), the screen data creating section 123a of the content display processing device 1 newly generates screen data D for displaying the electronic book data, which has been scrolled, in the area other than the display avoidance area Rb in the display area. Further, the combining section 125 generates another combined data by combining the newly generated screen data D with the video data M. At the time, the combining is carried out such that the video data M is provided into the display avoidance area Rb, as with the previous combining.

This causes the video data M to keep displayed in the same area, even though the display of the electronic book data is renewed. Moreover, the electronic book data is displayed in the area other than the display avoidance area Rb in the display area. With the configuration, it is possible to simultaneously display (i) the electronic book data, which can be scrolled, and (ii) the video data M, without causing the display area to have an area in which nothing is displayed, (d) of FIG. 2 illustrates a state where the electronic book data has been scrolled from the state illustrated in (c) of FIG. 2.

In the present embodiment, when the electronic book data is displayed, a character string, which is contained in the electronic book data, is assumed to be arranged in a longitudinal direction (vertical direction) in the display area. However, the present embodiment is not limited to this, and the character string may be arranged in a lateral direction (horizontal direction).

The content display processing device 1 has the following display modes (1) and (2): (1) a mode in which object sequence data and non-object-sequence data are simultaneously displayed (hereinafter, referred to as “simultaneous display mode”); and (2) a mode in which only object sequence data is displayed (hereinafter, referred to as “non-simultaneous display mode”). As later described, the content display processing device 1 can be switched between the simultaneous display mode and the non-simultaneous display mode. Note that (c) and (d) of FIG. 2 illustrate the processes carried out when the content display processing device 1 is in the simultaneous display mode.

In the present embodiment, the electronic book data and the video data M are simultaneously displayed. However, the present embodiment is not limited to this, and any combination of kinds of data can be employed, as early described, as long as (i) object sequence data such as a web page and (ii) non-object-sequence data are simultaneously displayed.

(Configuration of Content Display Processing Device)

The following describes a configuration of the content display processing device 1a with reference to FIG. 1. FIG. 1 is a block diagram illustrating a configuration of the content display processing device 1a.

The content display processing device 1a includes a main control section 100a, an operating section 200, and a storage section 300 (see FIG. 1). Note that a display device, which displays contents, may be provided in the content display processing device 1a. The following descriptions will discuss outlines of the sections 100a, 200, and 300.

The main control section 100a controls operations of the sections of the content display processing device 1a. The main control section 100a can by configured by, for example, a CPU (Central Processing Unit) or a memory. In this case, the main control section 100a executes each of various kinds of programs, which are stored in the storage section 300, by loading the program into a primary storage section configured by, for example, a RAM (Random Access Memory). With the configuration, the main control section 100a controls the sections of the content display processing device 1a so as to achieve functions of the content display processing device 1a. Detailed configuration of the main control section 100a will be described later.

The operating section 200 accepts an input by a user and sends a control signal, which corresponds to the input, to the main control section 100a. The operating section 200 is configured by an input device such as a remote controller, a switch, a mouse, or a keyboard.

In the descriptions below, it is assumed that the control signal is sent from the operating section 200 to the main control section 100a. However, the present embodiment is not limited to this. For example, in a case where the content display processing device 1a is controlled by an external device, it is possible that the content display processing device 1a receives a control signal from the external device, and the control signal thus received is transferred to the main control section 100a.

The operating section 200 accepts at least the following operations (1) through (4): (1) an operation for staring display of the electronic book data; (2) an operation for a user to go on reading the electronic book data; (3) an operation for ending the display of the electronic book data; and (4) an operation for switching the display mode. Note that the operation (1) is assumed to include a determination of the display mode. The operation (2) encompasses, more specifically, (i) an operation for scrolling the display of the electronic book data and (ii) an operation for moving, page by page, the display of the electronic book data. In the descriptions below, the operation (2) is assumed to be the operation for scrolling the display of the electronic book data, unless otherwise noted.

The control signal encompasses at least the following control signals (A) through (F): (A) a control signal for reading out electronic book data; (B) a control signal for starting display of electronic book data; (C) a control signal for renewing display of electronic book data; (D) a control signal for ending display of electronic book data; (E) a control signal for switching to simultaneous display mode; and (F) a control signal for switching to non-simultaneous display mode. Note that each of the control signals (B) and (C) includes an instruction on determining the display mode.

The operating section 200 sends the control signals (A) and (B) in response to the operation (1). The operating section 200 sends the control signal (C) in response to the operation (2). The operating section 200 sends the control signal (D) in response to the operation (3). The operating section 200 sends the control signal (E) or (F) in response to the operation (4).

The storage section 300 stores (1) control programs for the respective sections, (2) an OS program, (3) an application program, and (4) various kinds of data read out when the programs (1) through (3) are executed by the main control section 100a. The storage section 300 is configured by a ROM (Read Only Memory), a RAM (Random Access Memory), and the like. The storage section 300 stores, in particular, display screen information 311 and non-object-sequence area information (area information) 313.

The display screen information 311 is indicative of resolution of the entire display area. The non-object-sequence area information 313 is indicative of a rectangular area in the display area, in which rectangular area the non-object-sequence data (video data M) is displayed. The non-object-sequence area information 313 may be any information, as long as the information specifies a display position and a size of the rectangular area. Such information may be indicative of (i) a group of a coordinate of an upper left vertex of the rectangular area and a size of the rectangular area or (ii) a group of coordinates of the respective four vertexes of the rectangular area.

The non-object-sequence area information 313 is stored in the storage section 300, in such a state where validity of the non-object-sequence area information 313 can be externally referred to. Moreover, the non-object-sequence area information 313 can be externally made valid or invalid.

The following describes a detailed configuration of the main control section 100a. The main control section 100a includes a book data reading out section 111a, a book data clipping section 113, a scroll amount calculating section 115a, a display avoidance area calculating section (display avoidance area calculating means) 117, a data processing section (adding means) 119, an analyzing section 121a, a screen data creating section 123a, a combining section 125, a switching section (switching means) 127, a sub-information obtaining section (non-text content obtaining means, non-object-sequence obtaining means) 129, and an outputting section 131. The display avoidance area calculating section 117 and the data processing section 119 process the electronic book data such that the electronic book data is displayed in such a manner that the electronic book data avoids the display avoidance area Rb (details will be described later). The analyzing section 121a and the screen data creating section 123a carry out processes for displaying the electronic book data. The combining section 125 combines the electronic book data with the video data M. Note that the analyzing section 121a, the screen data creating section 123a, the combining section 125, and the outputting section 131 are collectively referred to as “display control section 133a”.

The following descriptions will discuss the sections of the main control section 100a.

The following description discusses the book data reading out section 111a. When the book data reading out section 111a receives, from the operating section 200, the control signal for reading out electronic book data, the book data reading out section 111a requests the book data clipping section 113 to notify (i) a starting point from which the electronic book data is read out (hereinafter, simply referred to as “read-out-starting point”) and (ii) a data amount by which the electronic book data is to be read out (hereinafter, simply referred to as “read-out data amount”).

Then, the book data reading out section 111a obtains, based on the read-out-starting point and the read-out data amount thus obtained, a part of the electronic book data from an external device (e.g., (i) a storage medium connected with the content display processing device 1a itself or (ii) an external device which communicates with the content display processing device 1a via a communication network) which manages the entire electronic book data. The book data reading out section 111a then sends the part of the electronic book data thus obtained to the book data clipping section 113. The book data reading out section 111a carries out the above process every time the book data reading out section 111a receives the control signal for reading out electronic book data.

The following description will discuss the book data clipping section 113. The book data clipping section 113 receives the part of the electronic book data from the book data reading out section 111a and holds the part of the electronic book data. When the book data clipping section 113 receives, from the operating section 200, any of the control signal for starting display of electronic book data and the control signal for renewing display of electronic book data, the book data clipping section 113 sends, to the display avoidance area calculating section 117 and the data processing section 119, a predetermined amount of electronic book data (hereinafter, referred to as “partial book data”) which has been selected (clipped), based on the display screen information 311 and the non-object-sequence area information 313 which are stored in the storage section 300, out of the part of the electronic book data which the book data clipping section 113 holds.

In a case where the book data clipping section 113 receives the control signal for starting display of electronic book data, the book data clipping section 113 (i) sends, to the display avoidance area calculating section 117 and the data processing section 119, a predetermined amount, from the starting point, of the partial book data, which has been clipped out of the part of the electronic book data received from the book data reading out section 111a and (ii) stores, as a starting point of sent data, the starting point of the predetermined amount of the partial book data thus sent.

In a case where the book data clipping section 113 receives the control signal for renewing display of electronic book data, the book data clipping section 113 (i) sends, to the display avoidance area calculating section 117 and the data processing section 119, a predetermined amount of partial book data starting from a new starting point, where the new starting point is a point shifted from the starting point of sent data by the number of characters corresponding to a scroll amount notified by the scroll amount calculating section 115a and (ii) stores, as a new starting point of sent data, the new starting point of the predetermined amount of the partial book data thus sent. Note that the number of characters corresponding to the scroll amount is obtained by multiplying, by the number of scrolled lines, the number of characters per line which number of characters has been obtained based on the display screen information 311 read out from the storage section 300.

The predetermined amount of partial book data, which is sent to the display avoidance area calculating section 117 and the data processing section 119, is a data amount that corresponds to the number of characters which (i) can be displayed in the display area and (ii) is calculated based on the display screen information 311 stored in the storage section 300.

When the book data clipping section 113 receives, from the book data reading out section 111a, the request for the read-out-starting point and the read-out data amount, the book data clipping section 113 notifies the book data reading out section 111a of (i) an end point (as the read-out-starting point) of the part of the electronic book data held by the book data clipping section 113 and (ii) a size of electronic book data (as the read-out data amount) which can be held by the book data clipping section 113.

When the book data clipping section 113 determines that held part of the electronic book data has been scrolled to near the end of the held part of the electronic book data, the book data clipping section 113 sends, to the book data reading out section 111a, a control signal for reading out electronic book data.

The book data clipping section 113 carries out such determination as follows. The book data clipping section 113 (i) counts the number of characters (hereinafter, referred to as “number X of characters”), which follow after the starting point of sent data, in the held part of the electronic book data and (ii) counts, based on the display screen information 311, the number of characters (hereinafter, referred to as “number Y of characters”) which can be displayed in an entire display screen. Then, in a case where the number Y of characters is larger than the number X of characters as a result of comparison between the number X of characters and the number Y of characters, the book data clipping section 113 determines that the held part of the electronic book data has been scrolled to near the end of the held part of the electronic book data. In this case, the read-out-starting point indicates the starting point of sent data, and the read-out data amount indicates the data amount which can be held by the book data clipping section 113.

After the book data clipping section 113 sends the partial book data, the book data clipping section 113 obtains a display end point from the display avoidance area calculating section 117, and holds the display end point as a starting point of partial book data which is to be sent next.

In a case where the operating section 200 accepts an operation for moving, by one (1) page, a display of the electronic book data, the book data clipping section 113 sends, in response to a control signal received from the operating section 200, partial book data for one (1) page, which starts from a display end point notified by the display avoidance area calculating section 117, to the display avoidance area calculating section 117 and the data processing section 119.

The following description discusses the scroll amount calculating section 115a. The scroll amount calculating section 115a (i) calculates a scroll amount of electronic book data based on the control signal, received from the operating section 200, for renewing display of electronic book data and (ii) notifies the book data clipping section 113 of the scroll amount thus calculated. Details of how to calculate the scroll amount will be described later.

The following description discusses the display avoidance area calculating section 117. When the display avoidance area calculating section 117 receives the partial book data from the book data clipping section 113, the display avoidance area calculating section 117 simulates, based on the received partial book data and the display screen information 311 stored in the storage section 300, how the received partial book data is displayed in the display area, and thereby the display avoidance area calculating section 117 generates an image of the partial book data which is to be displayed in the display area (hereinafter, referred to as “predicted screen image”). Then, the display avoidance area calculating section 117 calculates, based on the non-object-sequence area information 313 stored in the storage section 300, a display avoidance area Rb in the predicted screen image generated above. The display avoidance area calculating section 117 then sends, to the data processing section 119, display avoidance area information indicative of the display avoidance area Rb calculated above. Note that the display avoidance area Rb is an area which encompasses a non-object-sequence area (non-text display area, non-object-sequence display area) Rn indicated by the non-object-sequence area information 313. Details of a relation between the display avoidance area Rb and the non-object-sequence area Rn will be described later.

Note that, in a case where the non-object-sequence area information 313, which is stored in the storage section 300, is invalid (i.e., in a case the display mode is the non-simultaneous display mode), the display avoidance area calculating section 117 notifies the data processing section 119 that there is no display avoidance area information.

Here, the display avoidance area information contains pieces of information respectively indicative of (i) a size of a blank image object which is provided in the display avoidance area Rb and (ii) a position in the partial book data at which position the blank image object is inserted.

The pieces of information which constitute the display avoidance area information are appropriately determined depending on how partial book data is processed by the data processing section 119. In the present embodiment, the blank image object is inserted into the electronic book data such that the partial book data is arranged in an area other than the non-object-sequence area Rn in the display section. In view of this, the display avoidance area information contains the pieces of information respectively indicative of (i) the size of the blank image object and (ii) the position at which the blank image object is inserted. However, the present embodiment is not limited to this. In a case where, for example, a line feed is inserted into the partial book data by the data processing section 119 such that the partial book data is arranged in an area other than the non-object-sequence area Rn in the display section, information indicative of a position at which the line feed is inserted may be used as the display avoidance area information.

Further, the display avoidance area calculating section 117 simulates how the partial book data, into which the display avoidance area Rb has been inserted, is displayed in the display area, and thereby the display avoidance area calculating section 117 again generates a predicted screen image of the partial book data which is to be displayed in the display area. Then, the display avoidance area calculating section 117 notifies the book data clipping section 113 of, as the display end point, an end point of the partial book data which is displayed in the predicted screen image. Details of the process carried out by the display avoidance area calculating section 117 will be described later.

The following description discusses the data processing section 119. When the data processing section 119 receives (i) the partial book data from the book data clipping section 113 and (ii) the display avoidance area information from the display avoidance area calculating section 117, the data processing section 119 inserts, based on the display avoidance area information thus received, a blank image object into the partial book data thus received. Then, the data processing section 119 sends, to the analyzing section 121a, the partial book data into which the blank image object has been inserted.

Note that, in a case where the data processing section 119 is notified, by the display avoidance area calculating section 117, that there is no non-object-sequence area information 313, the data processing section 119 sends, to the analyzing section 121a, the partial book data, which has been received from the book data clipping section 113, as it is.

The following description discusses the analyzing section 121a. When the analyzing section 121a receives the partial book data from the data processing section 119, the analyzing section 121a generates analysis data by analyzing the partial book data thus received. Here, in the analysis, characters, a blank image object, and the like contained in the partial book data are extracted. Then, the analyzing section 121a sends the analysis data thus generated to the screen data creating section 123a.

The analyzing section 121a holds display attribute information which contains pieces of information respectively indicative of (i) a maximum character size, (ii) a maximum character spacing, and (iii) a maximum line spacing, in displaying characters, which are contained in the partial book data, in the display area. The display attribute information is used when the display avoidance area calculating section 117 calculates the display avoidance area Rb.

The following description discusses the screen data creating section 123a. The screen data creating section 123a (i) obtains the display screen information 311 from the storage section 300, and (ii) generates screen data D for displaying the partial book data in the display area. The screen data creating section 123a generates the screen data D in accordance with resolution indicated by the display screen information 311 thus obtained and based on the analysis data received from the analyzing section 121a. The screen data creating section 123a sends the screen data D thus generated to the combining section 125.

The following description discusses the combining section 125. When the combining section 125 receives the screen data D of the partial book data from the screen data creating section 123a, the combining section 125 refers to the display mode held by the switching section 127. In a case where the display mode held by the switching section 127 is the simultaneous display mode, the combining section 125 (i) obtains the non-object-sequence area information 313 from the storage section 300 and (ii) sends, to the sub-information obtaining section 129, a request to obtain a video data M (hereinafter, referred to as “sub-information obtaining request”) which is to be displayed in the non-object-sequence area Rn. Subsequently, the combining section 125 receives, from the sub-information obtaining section 129, the video data M as a response to the sub-information obtaining request, and then generates combined data by providing the video data M thus received into the non-object-sequence area Rn in the screen data D, which the combining section 125 has received from the screen data creating section 123a. The combining section 125 then sends the combined data thus generated to the outputting section 131. The combining process to combine the video data M with the screen data D and the sending process to send the combined data to the outputting section 131 are repeatedly carried out every time the combining section 125 receives the video data M from the sub-information obtaining section 129.

On the other hand, in a case where the display mode held by the switching section 127 is the non-simultaneous display mode, the data that the combining section 125 supplies to the outputting section 131 as if the data is the “combined data” is the screen data D as it is, which has been received from the screen data creating section 123a.

In a case where the display mode is switched from the simultaneous display mode to the non-simultaneous display mode, or in a case where the combining section 125 receives, from the operating section 200, the control signal for ending display of electronic book data, the combining section 125 sends, to the sub-information obtaining section 129, a request to terminate obtaining the video data M (hereinafter, referred to as “sub-information obtaining termination request”). Further, in the case where the combining section 125 receives, from the operating section 200, the control signal for ending display of electronic book data, the combining section 125 stops sending the combined data to the outputting section 131.

The following description discusses the switching section 127. The switching section 127 holds the display mode, such that the display mode can be externally referred to. In a case where the switching section 127 receives, from the operating section 200, the control signal for switching to simultaneous display mode, the switching section 127 (i) sets the display mode to the simultaneous display mode and (ii) makes valid the non-object-sequence area information 313 stored in the storage section 300. On the other hand, in a case where the switching section 127 receives, from the operating section 200, the control signal for switching to non-simultaneous display mode, the switching section 127 (i) sets the display mode to the non-simultaneous display mode and (ii) makes invalid the non-object-sequence area information 313 stored in the storage section 300.

The following description discusses the sub-information obtaining section 129. The sub-information obtaining section 129 externally obtains the video data M. When the sub-information obtaining section 129 receives the sub-information obtaining request from the combining section 125, the sub-information obtaining section 129 sends the video data M, which has been externally obtained, to the combining section 125. Note that the sub-information obtaining section 129 continuously obtains the video data and sends the video data M to the combining section 125 until the sub-information obtaining section 129 receives the sub-information obtaining termination request from the combining section 125.

The following description discusses the outputting section 131. The outputting section 131 supplies the combined data, which has been received from the combining section 125, to the display device. As early described, the outputting section 131 is not limited to supplying the combined data to the display device, but (i) may cause the combined data to be stored in a storage medium which is connected with the content display processing device 1a or (ii) may transmit the combined data to an external device via a communication network.

(Process Flow)

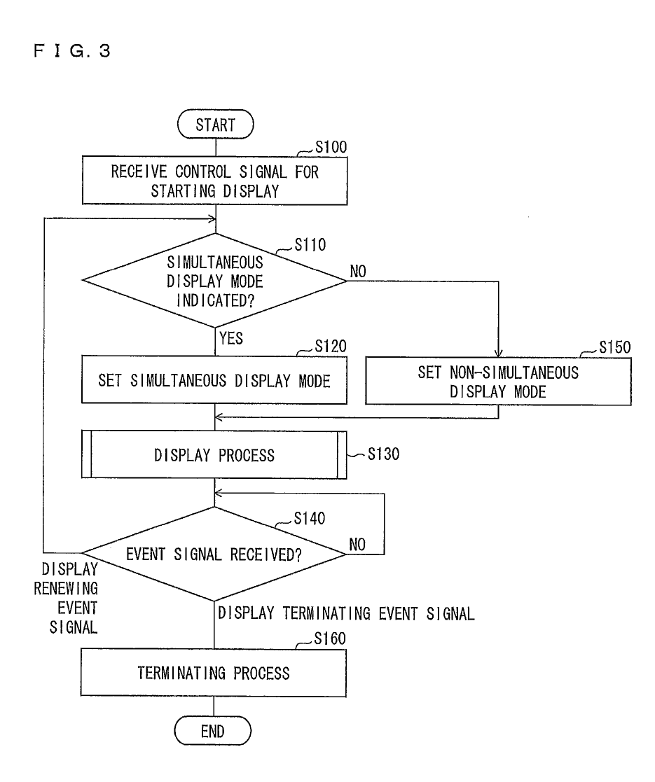

The following describes, with reference to FIG. 3, an example of processes carried out by the sections of the content display processing device 1a when the electronic book data is displayed. FIG. 3 is a flowchart illustrating an example of a flow of processes carried out in the content display processing device 1a.

First, when the operating section 200 accepts an input for starting a display of the electronic book data, the book data clipping section 113 receives, from the operating section 200, the control signal for starting display of electronic book data (step (hereinafter, simply abbreviated as “S”) 100).

In a case where the display mode specified by the control signal thus received is the simultaneous display mode (YES in S110), the switching section 127 (i) sets the display mode to the simultaneous display mode and (ii) makes valid the non-object-sequence area information 313 stored in the storage section 300 (S120). On the other hand, in a case where the display mode specified by the control signal, which has been received, is the non-simultaneous display mode (NO in S110), the switching section 127 (i) sets the display mode to the non-simultaneous display mode and (ii) makes invalid the non-object-sequence area information 313 stored in the storage section 300 (S150).

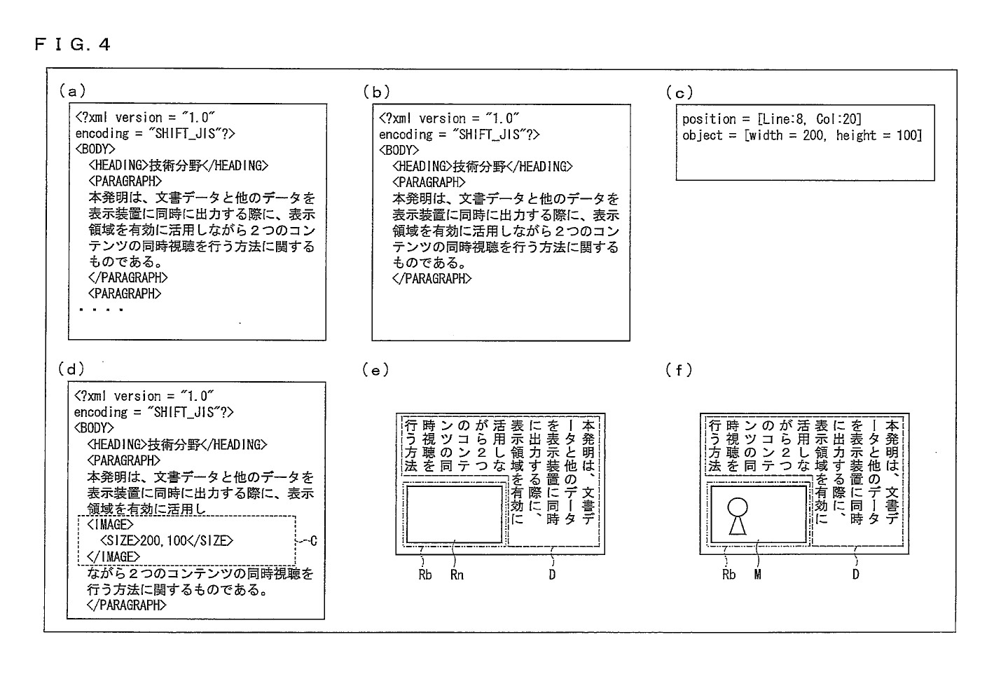

Then, the book data reading out section 111a, which has been received, from the operating section 200, the control signal for reading out electronic book data, obtains a part of electronic book data and sends the part of electronic book data thus obtained to the book data clipping section 113. (a) of FIG. 4 illustrates an example of the part of electronic book data which is sent from the book data reading out section 111a to the book data clipping section 113. Note that (a) of FIG. 4 merely exemplifies the electronic book data, and the electronic book data, which is illustrated in (a) through (f) of FIG. 4, can vary depending on what kind of format the electronic book data employs.

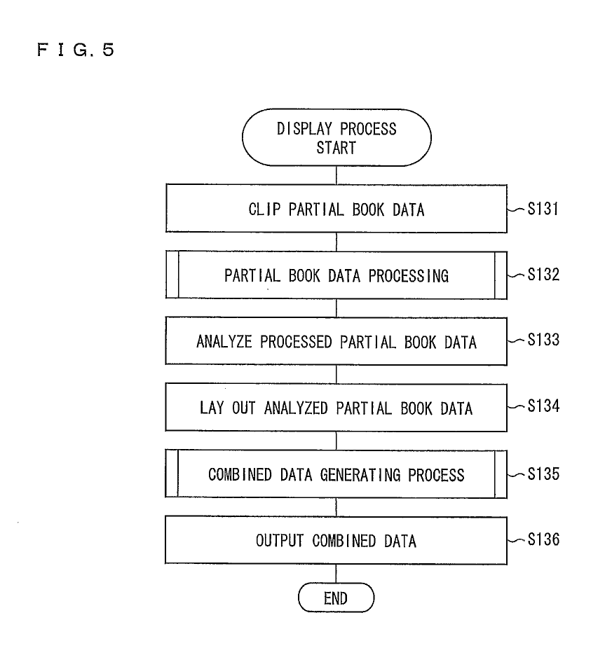

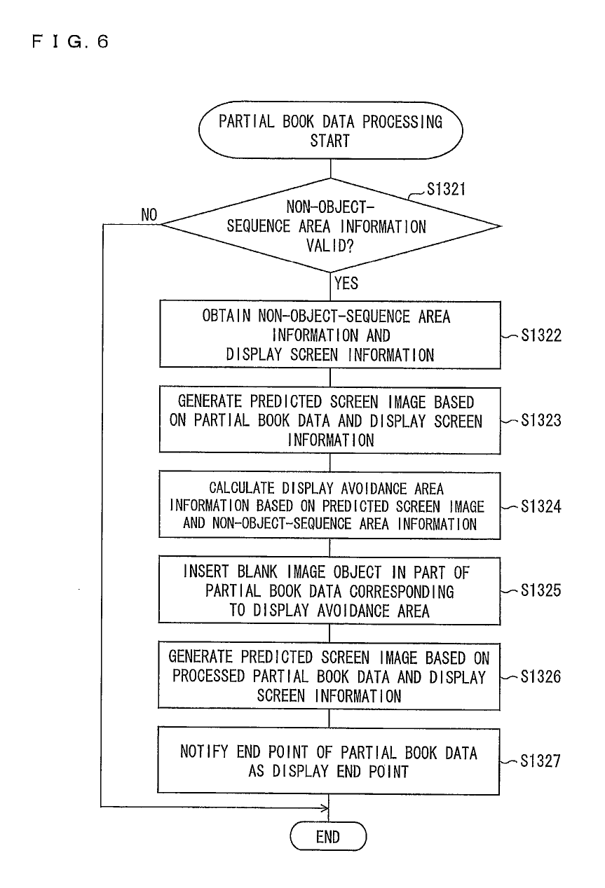

Then, a process to display the partial book data is carried out by the book data clipping section 113, the display avoidance area calculating section 117, the data processing section 119, the analyzing section 121a, the screen data creating section 123a, the combining section 125, and the outputting section 131 (S130). Details of the display process will be described later with reference to a flowchart illustrated in FIG. 5.

In a case where the main control section 100a receives, from the operating section 200, a display renewing event signal (later described) (“display renewing event signal” in S140) after the display process is ended, the process returns to the step S110, and a process to display partial book data, which is displayed after scrolling, is carried out.

On the other hand, in a case where the main control section 100a receives, from the operating section 200, a display terminating event signal (later described) instead of the display renewing event signal (“display terminating event signal” in S140), the combining section 125 stops sending data to the outputting section 131 (S160). Note that, in a case where the main control section 100a does not receive the display terminating event signal (NO in S140), the process returns to the step S140.

Here, the “display renewing event signal” indicates any one of the control signal for renewing display of electronic book data, the control signal for switching to simultaneous display mode, and the control signal for switching to non-simultaneous display mode. On the other hand, the “display terminating event signal” indicates the control signal for ending display of electronic book data.

(Flow of Display Process)

The following description discusses how the process to display partial book data is carried out, with reference to FIG. 5. FIG. 5 is a flowchart illustrating how the process to display the partial book data is carried out.

First, when the book data clipping section 113 receives, from the operating section 200, the control signal for starting display of electronic book data or the control signal for renewing display of electronic book data, the book data clipping section 113 sends partial book data to the display avoidance area calculating section 117 and to the data processing section 119 (S131). (b) of FIG. 4 illustrates an example of the partial book data, which is sent from the book data clipping section 113 in the step S131.

Next, the partial book data is processed, by the display avoidance area calculating section 117 and the data processing section 119, such that the display avoidance area Rb is inserted into the partial book data (S132). Details of how to process the partial book data will be described later, with reference to a flowchart illustrated in FIG. 6. The partial book data, which has been processed, is analyzed by the analyzing section 121a, and analysis data is sent to the screen data creating section 123a (S133).

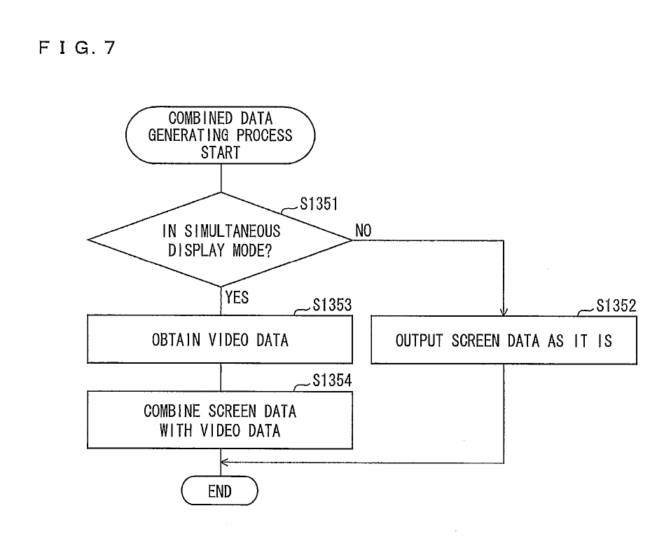

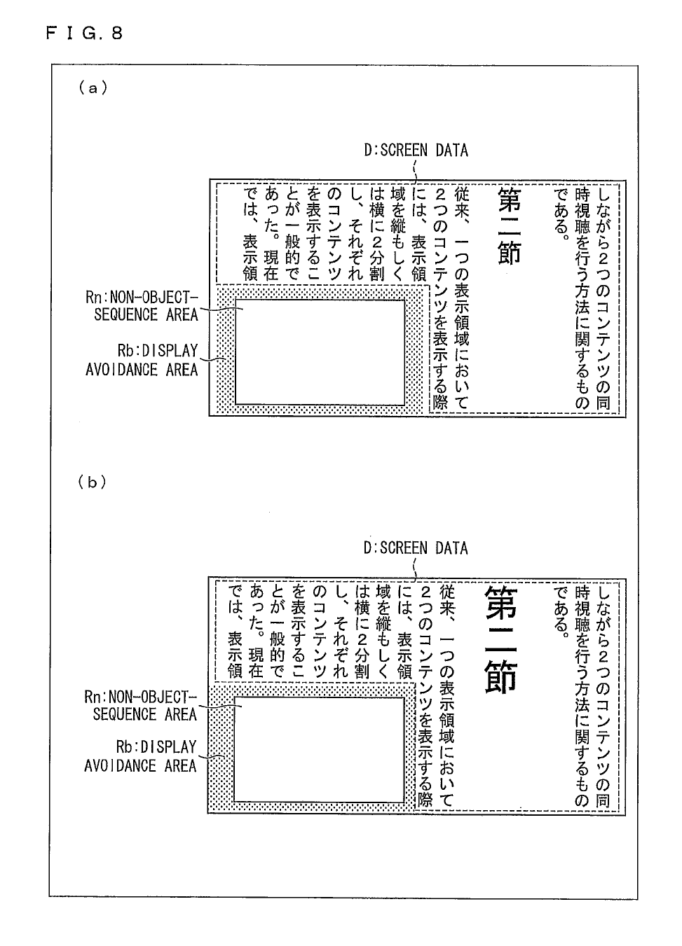

Then, the screen data creating section 123a (i) obtains the display screen information 311 from the storage section 300 when the screen data creating section 123a receives the analysis data from the analyzing section 121a, then (ii) generates, based on the display screen information 311 thus obtained, screen data D for laying out the partial book data in the display area, and then (iii) sends the screen data D thus generated to the combining section 125 (S134). When the combining section 125 receives the screen data D from the screen data creating section 123a, the combining section 125 generates combined data by combining the screen data D and the video data M, and then sends the combined data thus generated to the outputting section 131 (S135). Details of the combined data generating process will be described later with reference to a flowchart illustrated in FIG. 7.

Lastly, the outputting section 131 supplies the combined data, which has been received from the combining section 125, to the display device (S136).

(Flow of Processing Partial Book Data)

The following description discusses how to process the partial book data, with reference to FIG. 6. FIG. 6 is a flowchart illustrating a flow of processing partial book data.

First, when the display avoidance area calculating section 117 receives the partial book data from the book data clipping section 113, the display avoidance area calculating section 117 judges whether or not layout prohibiting area information stored in the storage section 300 is valid (S1321).

In a case where the non-object-sequence area information 313 is invalid (NO in S1321), the partial book data is not processed by the display avoidance area calculating section 117 and the data processing section 119, and this processing flow is ended. On the other hand, in a case where the non-object-sequence area information 313 is valid (YES in S1321), the display avoidance area calculating section 117 obtains the non-object-sequence area information 313 and the display screen information 311 from the storage section 300 (S1322).

Then, the display avoidance area calculating section 117 generates predicted screen image by simulating, based on the display screen information 311 thus obtained, how the partial book data, which has been received from the book data clipping section 113, is displayed in the display area (S1323).

Further, the display avoidance area calculating section 117 calculates, based on the predicted screen image thus generated and on the non-object-sequence area information 313 thus obtained, display avoidance area Rb in which the partial book data is not displayed when the partial book data is displayed in the display area. Then, the display avoidance area calculating section 117 sends, to the data processing section 119, display avoidance area information being indicative of the display avoidance area Rb thus calculated (S1324). (c) of FIG. 4 illustrates an example of the display avoidance area information which is sent from the display avoidance area calculating section 117 in the step S1324. In the example shown in (c) of FIG. 4, a position of the display avoidance area Rb is specified as 20th byte on 8th line (position=[Line:8, Col:20]). Moreover, a size of an image object (object), which is to be inserted as the display avoidance area Rb, is determined to have a width of 200 and a height of 100 (object=[width=200, height=100]).

When the data processing section 119 receives the display avoidance area information, the data processing section 119 inserts, based on the display avoidance area information thus received, a blank image object into the partial book data (S1325).

(d) of FIG. 4 illustrates an example of the partial book data into which the image object has been inserted in the step S1325. A tag C, which is shown in (d) of FIG. 4, indicates the image object which has been inserted into the partial book data. As shown in (d) of FIG. 4, the image object, which has the specified size, is inserted into the partial book data at the position specified as shown in (c) of FIG. 4, i.e., at 20th byte on 8th line, (e) of FIG. 4 illustrates data which is generated by the screen data creating section 123a based on the data shown in (d) of FIG. 4. The display avoidance area Rb, in which the partial book data is not displayed, is provided so as to encompass the non-object-sequence area Rn (see (e) of FIG. 4).

Meanwhile, the display avoidance area calculating section 117 again generates predicted screen image by simulating, based on (i) the electronic book data into which the display avoidance area Rb has been inserted and on (ii) the display screen information 311, how the partial book data, into which the display avoidance area Rb has been inserted, is displayed in the display area (S1326).

Then, the display avoidance area calculating section 117 notifies the book data clipping section 113 of, as a display end point, the end point of the partial book data displayed in the predicted screen image (S1327).

(Flow of Combined Data Generating Process)

The following description discusses how the combined data generating process is carried out, with reference to FIG. 7. FIG. 7 is a flowchart illustrating a flow of the combined data generating process.

First, when the combining section 125 receives the screen data D from the screen data creating section 123a, the combining section 125 refers to the display mode held by the switching section 127 (S1351).

In a case where the display mode is the non-simultaneous display mode (NO in S1351), the combining section 125 sends the screen data D as it is, which has been received from the screen data creating section 123a, to the outputting section 131 (S1352). On the other hand, in a case where the display mode is the simultaneous display mode (YES in S1351), the combining section 125 sends the sub-information obtaining request to the sub-information obtaining section 129, and obtains, as a response to the sub-information obtaining request, the video data M from the sub-information obtaining section 129 (S1353).

Then, the combining section 125 generates combined data by providing the video data M thus obtained into the non-object-sequence area Rn in the screen data D, which has been received from the screen data creating section 123a (S1354). (f) of FIG. 4 illustrates an example of the combined data generated in the step S1354. As shown in (f) of FIG. 4, the video data M is provided into the non-object-sequence area Rn.

As described above, (i) the partial book data is displayed so as not to be displayed in the display avoidance area Rb and (ii) the video data M is provided into the non-object-sequence area Rn, which has been inserted into the partial book data. This allows the electronic book data to be scrolled while the video data M is constantly displayed at the same position.

(Relation Between Non-Object-Sequence Area Rn and Display Avoidance Area Rb)

The following description discusses a relation between the non-object-sequence area Rn and the display avoidance area Rb, with reference to FIG. 8. (a) of FIG. 8 is a schematic view illustrating a relation between the non-object-sequence area Rn and the display avoidance area Rb. (b) of FIG. 8 is a schematic view-illustrating a state where the display avoidance area Rb is changed due to existence of characters having a large font size.

In displaying the electronic book data, in some cases, changing at least any of a font size of character, a line spacing, a character spacing, and an indent would positionally shift the characters from where the characters has been displayed. Under such circumstances, in a case where the non-object-sequence area Rn is provided by inserting an image object or a line feed into the partial book data such that the characters of the partial book data are displayed while avoiding the non-object-sequence area Rn, the non-object-sequence area Rn cannot be fixedly defined (in accordance with the change in positions of the characters), as long as the position in the partial book data, at which position the image object or the line feed is inserted, is specified by the number of lines and the number of characters.

In such a case, if the electronic book data is displayed under a condition where the display avoidance area Rb is set to have a size identical with that of the non-object-sequence area Rn in which the video data M is displayed, the position of the display avoidance area Rb can be changed every time the display of the electronic book data is renewed, and accordingly, an area, in which the electronic book data is displayed, can be changed. As a result, the video data M and the partial book data may be displayed while overlapping each other.

In order to deal with such a problem, the display avoidance area calculating section 117 calculates the display avoidance area Rb (see (a) of FIG. 8), which is different from the non-object-sequence area Rn in which the video data M is displayed. Here, the display avoidance area calculating section 117 calculates the display avoidance area Rb based on the display attribute information obtained from the analyzing section 121a. In this case, the display avoidance area Rb is generated such that the non-object-sequence area Rn is encompassed in the display avoidance area Rb, even when the display avoidance area Rb is changed due to change of at least the font size of character, the line spacing, and the character spacing (see (b) of FIG. 8).

Specifically, the display avoidance area Rb is set to have a horizontal length which is longer than that of the non-object-sequence area Rn by a length not shorter than a length defined as follows: (possible maximum line spacing+possible maximum character size)/2. Moreover, the display avoidance area Rb is set to have a vertical length which is longer than that of the non-object-sequence area Rn by a length not shorter than a length defined as follows: (possible maximum character spacing+possible maximum character size)/2. With the configuration, the display avoidance area Rb encompasses the non-object-sequence area Rn, even in a case where the display avoidance area Rb is positionally shifted due to change of any of the font size of character, the line spacing, and the character spacing, in the electronic book data. This makes it possible to prevent the video data M and the partial book data from being displayed while overlapping each other.

(Control of Scroll Amount)

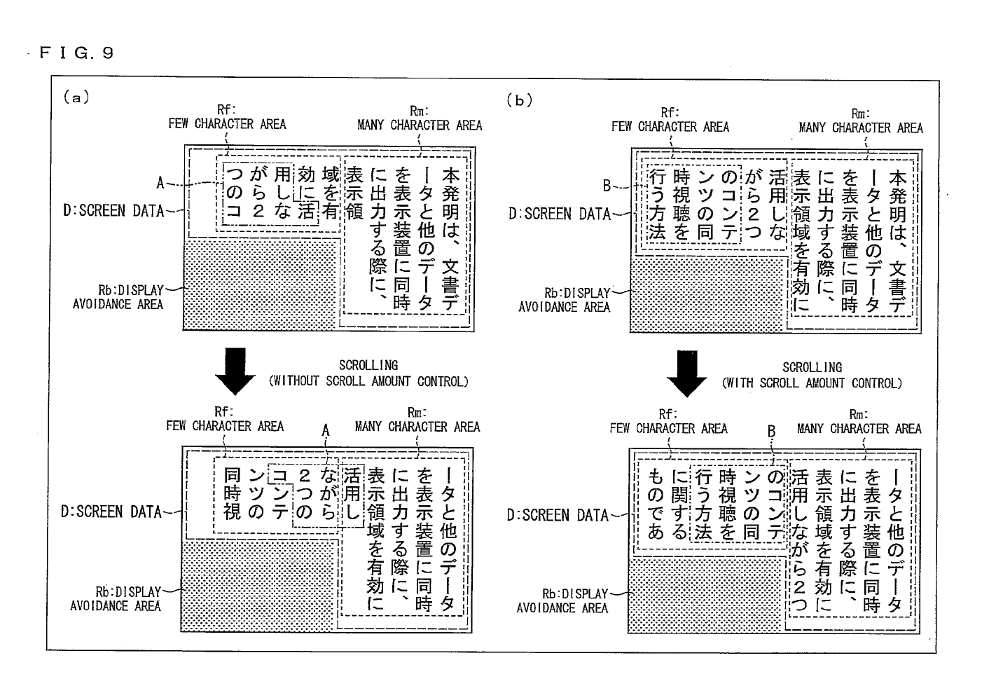

The following description discusses, with reference to FIG. 9, a scroll amount by which the electronic book data is scrolled, (a) of FIG. 9 is a schematic view illustrating how characters are displayed, when the electronic book data is scrolled without restriction of scroll amount. (b) of FIG. 9 is a schematic view illustrating how characters are displayed, when electronic book data is scrolled with restriction of scroll amount. Note that, in the examples shown in FIG. 9, the electronic book data is scrolled in a direction from left to right in FIG. 9.

For convenience, in the description below, it is assumed that a character string contained in the electronic book data is arranged in a longitudinal direction (vertical direction). Moreover, it is assumed that characters contained in the electronic book data are displayed with a predetermined character size, a predetermined line spacing, and a predetermined character spacing, which will not be changed. Further, the display avoidance area Rb is assumed to have a rectangular shape.

In a case where, for example, the electronic book data is displayed in a rectangular shaped area, the number of characters, which can be displayed in each line, does not change. Therefore, even when the electronic book data is scrolled line by line in the horizontal direction, a vertical arrangement of the characters in each line will not be changed. However, as in the present invention, in a case where the electronic book data is displayed in the display area so as not to be displayed in the display avoidance area Rb which is provided in the display area, the number of characters, which can be displayed in each line, is to vary depending on areas in the display area. In such a case, it may be possible that vertical positions of the characters in each line are changed when the electronic book data is scrolled line by line.

The following explains such a case, with reference to (a) of FIG. 9. In the example shown in (a) of FIG. 9, the display area has (i) an area (hereinafter, referred to as “many character area Rm”) in which eight characters can be displayed per line and (ii) an area (hereinafter, referred to as “few character area Rf”) in which three characters can be displayed per line. Note that, in the example shown in FIG. 9, the many character area Rm corresponds to a “second area” recited in the claims of the subject application and the few character area Rf corresponds to a “first area” recited in the claims of the subject application.

In this case, when the electronic book data is scrolled by an amount corresponding to one (1) line (i.e., eight characters) in the many character area Rm, the characters in the few character area Rf are to be moved by an amount corresponding to two lines of the few character area Rf in the horizontal direction and two characters in the vertical direction. As such, the characters in the few character area Rf are moved by two characters in the vertical direction, that is, the characters in the few character area Rf are to be moved not only in the horizontal direction but also in the vertical direction, as indicated by a character string A in (a) of FIG. 9. This causes a problem as follows: that is, in the case where the characters of the electronic book data is vertically moved when the electronic book data is horizontally scrolled, it becomes difficult for a user to read the electronic book data.

In order to avoid such a problem, the scroll amount calculating section 115a sets a minimum unit of scroll amount when the scroll amount calculating section 115a calculates a scroll amount in response to the control signal for renewing display of electronic book data.

When the scroll amount calculating section 115a receives the control signal for renewing display of electronic book data, the scroll amount calculating section 115a obtains (i) the display avoidance area information from the display avoidance area calculating section 117 and (ii) the display screen information 311 from the storage section 300.

Then, the scroll amount calculating section 115a calculates, based on the display screen information 311 and the display avoidance area information thus obtained, (i) the number of characters (hereinafter, referred to as “the number α of characters”) which can be displayed per line in the many character area Rm and (ii) the number of characters (hereinafter, referred to as “the number β of characters”) which can be displayed per line in the few character area Rf.

Then, the minimum unit of scroll amount is set to be the number of lines in the many character area Rm, which number of lines corresponds to a least common multiple of the number α of characters and the number β of characters.

The number of characters, which corresponds to the minimum unit of scroll amount obtained above, is a multiple of the number β of characters. Therefore, characters in the few character area Rf, which will not be moved to the many character area Rm by scrolling, will be moved only in the horizontal direction but will not be moved in the vertical direction. In the example shown in (b) of FIG. 9, the number α of characters is 8 and the number β of characters is 4. In such a case, when the electronic book data is moved by 8 characters, which is a least common multiple of the number α of characters and the number β of characters, the characters indicated by a character string B in (b) of FIG. 9 are not moved in the vertical direction.

By the process above described, it is possible to prevent the characters, which are displayed in the few character area Rf before and after scrolling, from being moved in the vertical direction by the scrolling.

Note that, in a case where the display avoidance area Rb does not have the rectangular shape, the electronic book data may be scrolled by a minimum scroll amount of one (1) page, instead of being scrolled line by line.

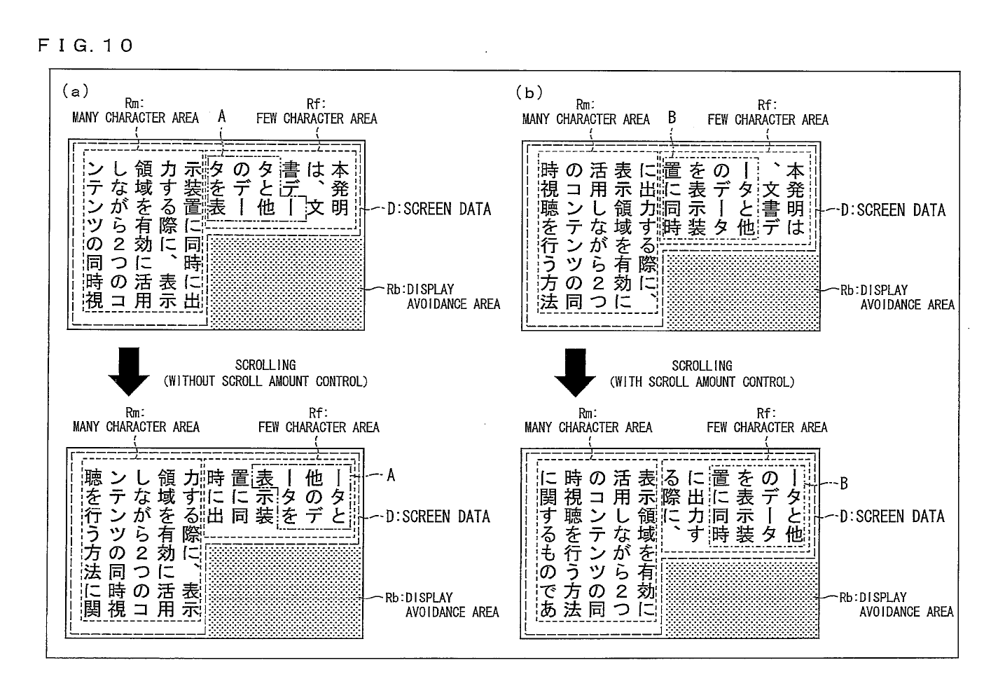

In the example of FIG. 9, the display avoidance area Rb is located on lower left of the display area. However, the method for calculating the minimum unit of scroll amount above described can be applied to a case where the display avoidance area Rb is located at a different position in the display area. FIG. 10 illustrates, as an example, a case where the display avoidance area Rb is located on lower right of the display area, (a) and (b) of FIG. 10 are schematic views illustrating modifications of (a) and (b) of FIG. 9, respectively. In the modifications, the display avoidance area Rb is located on lower right in the display area. In the example shown in FIG. 10, the scroll amount is controlled in a manner similar to that in the example shown in FIG. 9.

In the example shown FIG. 10, the display avoidance area Rb is located on lower right of the display area. In this case, the many character area Rm corresponds to the “first area” recited in the claims of the subject application and the few character area Rf corresponds to the “second area” recited in the claims of the subject application.

### Embodiment 2

The following description will discuss an embodiment in which functions similar to those of Embodiment 1 are achieved by different configurations.

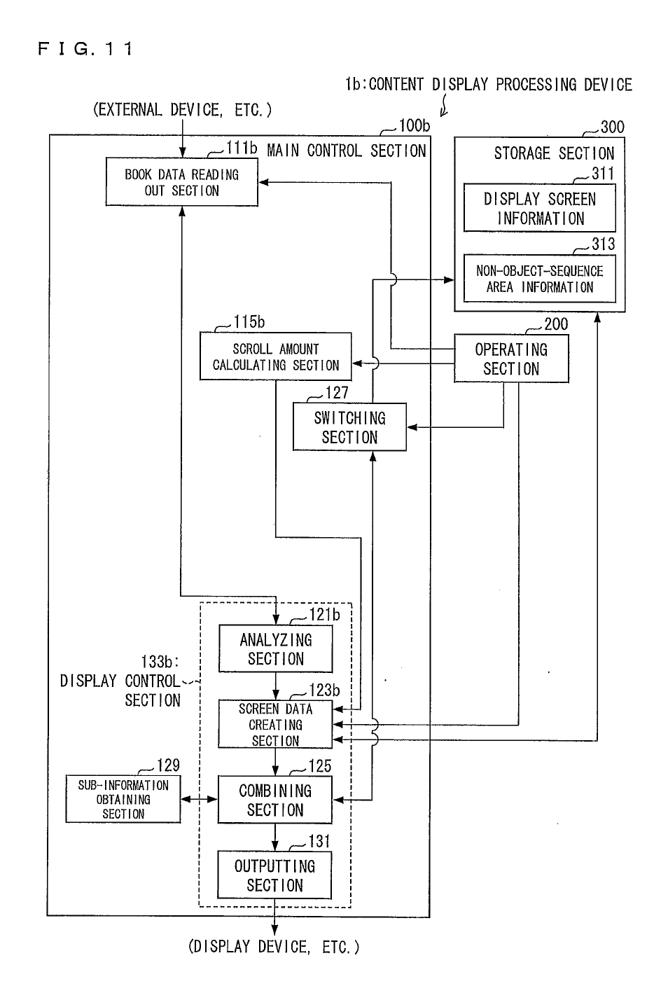

The following describes another embodiment of the present invention with reference to FIGS. 11 through 14. For convenience of explanation, the same reference numerals are given to members which have functions identical with those of Embodiment 1, and explanations of such members are omitted. Similarly, the same reference numerals are given to processes which are identical with those of Embodiment 1, and explanations of such processes are omitted.

(Configuration of Content Display Processing Device)

The following description discusses a content display processing device 1b of the present embodiment, with reference to FIG. 11. FIG. 11 is a block diagram illustrating a configuration of the content display processing device 1b.

The content display processing device 1b includes a main control section 100b, an operating section 200, and a storage section 300 (see FIG. 11). The following describes outlines of sections of the content display processing device 1b, which are different from those of Embodiment 1.

The main control section 100b is different from the main control section 100a of Embodiment 1 in terms of the following points. That is, the main control section 100b does not include the book data clipping section 113, the display avoidance area calculating section 117, and the data processing section 119. Moreover, the main control section 100b includes (i) a book data reading out section 111b instead of the book data reading out section 111a, (ii) an analyzing section 121b instead of the analyzing section 121a, (iii) a scroll amount calculating section 115b instead of the scroll amount calculating section 115a, and (iv) a screen data creating section (adding means, display avoidance area calculating means) 123b instead of the screen data creating section 123a. Note that the analyzing section 121b, the screen data creating section 123b, a combining section 125, and an outputting section 131 are collectively referred to as “display control section 133b”.

When the book data reading out section 111b receives, from the main control section 100b, an instruction on reading out electronic book data, the book data reading out section 111b obtains a part of electronic book data from an external device which manages the entire electronic book data. Then, the book data reading out section 111b sends the part of electronic book data thus obtained to the analyzing section 121b.

Next, the analyzing section 121b decodes (decrypts or decompressed) the part of electronic book data received from the book data reading out section 111b.

Then, the scroll amount calculating section 115b notifies the screen data creating section 123b of a scroll amount which has been calculated in response to a control signal, received from the operating section 200, for renewing display of electronic book data. Details of the process for calculating the scroll amount are identical with those described in Embodiment 1. Therefore, explanation of the process for calculating the scroll amount is omitted here.

Then, the screen data creating section 123b lays out the electronic book data in an area (non-rectangular shaped area) in a display area other than a display avoidance area Rb which is also in the display area.

(Flow of Processes)

The following describes, with reference to FIG. 3, an example of processes carried out by the sections of the content display processing device 1b when the electronic book data is displayed. Here, only processes are described which are different from those carried out by the sections of the content display processing device 1a explained in Embodiment 1.

When the operating section 200 accepts an operation for starting display of electronic book data in a step S100, the operating section 200 sends, to the book data reading out section 111b, a control signal for reading out electronic book data.

In a step S130, the book data reading out section 111ab, which has been received, from the operating section 200, the control signal for reading out electronic book data, (i) obtains a part of electronic book data and (ii) sends the part of electronic book data thus obtained to the screen data creating section 123b. Then, a process for displaying partial book data, which is selected out of the part of the electronic book data, is carried out by the analyzing section 121b, the screen data creating section 123b, the combining section 125, and the outputting section 131. Details of the display process will be described later, with reference to a flowchart illustrated in FIG. 11.

(Flow of Display Process)

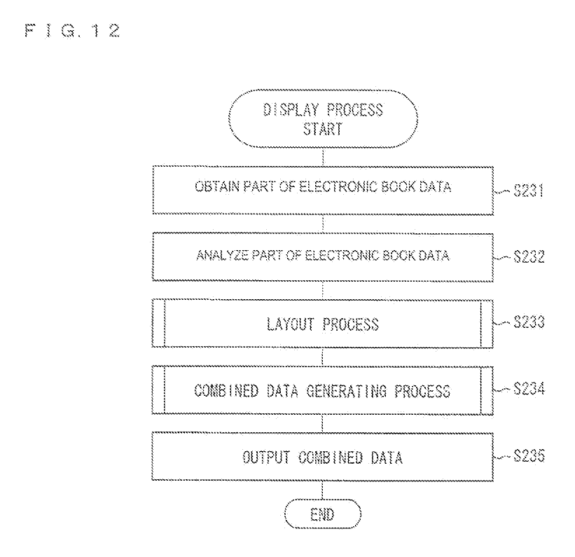

The following describes how the partial book data is displayed, with reference to FIG. 12. FIG. 12 is a flowchart illustrating a flow of a process to display the partial book data.

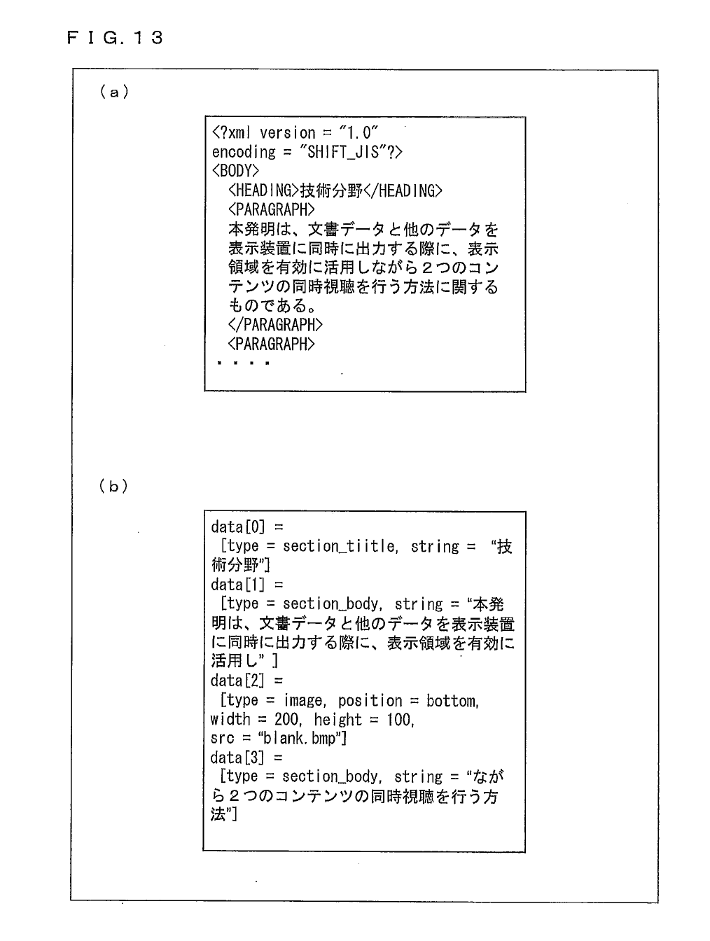

When the book data reading out section 111b receives, from the operating section 200, a control signal for starting display of electronic book data or a control signal for renewing display of electronic book data, the book data reading out section 111b obtains a part of electronic book data and sends the part of electronic book data thus obtained to the analyzing section 121b (S231). FIG. 13 illustrates an example of data sent or received by each of the sections of the present embodiment. In actuality, data, which is obtained by encrypting or compressing data shown in (a) of FIG. 13, is sent and received.

The analyzing section 121b (i) generates analysis data by decoding and analyzing the part of electronic book data thus received, and (ii) sends the analysis data to the screen data creating section 123b (S232). (b) of FIG. 13 illustrates an example of the analysis data which has been generated by the analysis carried out by the analyzing section 121b and is sent to the screen data creating section 123b.

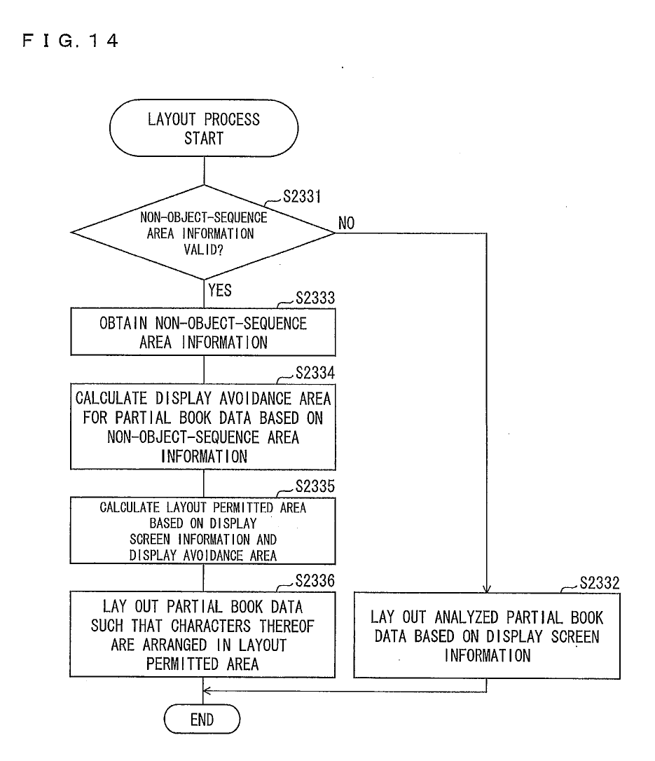

When the screen data creating section 123b receives the analysis data from the analyzing section 121b, the screen data creating section 123b also obtains non-object-sequence area information 313 and display screen information 311 from the storage section 300. Then, the screen data creating section 123b (i) generates screen data D by converting the partial book data into the screen data D, based on the analysis data and the non-object-sequence area information 313, and (ii) sends the screen data D thus generated to the combining section 125 (S233). Details of the process carried out by the screen data creating section 123b will be described later with reference to a flowchart illustrated in FIG. 14.

When the combining section 125 receives the screen data D from the screen data creating section 123b, the combining section 125 (i) generates combined data by combining the screen data D with video data M and then (ii) sends the combined data to the outputting section 131 (S234).

Lastly, the outputting section 131 supplies the combined data, which has been received from the screen data creating section 123b, to a display device (S235).

(Flow of Layout Process)

The following description discusses, with reference to FIG. 14, how the electronic book data is laid out by the screen data creating section 123b. FIG. 14 is a flowchart illustrating a flow of a layout process included in the flowchart shown in FIG. 12.

First, the screen data creating section 123b judges whether or not the non-object-sequence area information 313, which is stored in the storage section 300, is valid (S2331). In a case where the non-object-sequence area information 313 is invalid (NO in S2331), the screen data creating section 123b creates the screen data from partial book data, based on the display screen information 311 (S2332). In a case where the non-object-sequence area information 313 is valid (YES in S2331), the screen data creating section 123b obtains the non-object-sequence area information 313 and the display screen information 311 (S2333), and the screen data creating section 123b calculates, based on the non-object-sequence area information 313, the display avoidance area Rb in which the partial book data is not displayed (S2334). Here, the method for calculating the display avoidance area Rb is the same as that carried out by the display avoidance area calculating section 117 explained in Embodiment 1. Therefore, explanation of the method for calculating the display avoidance area Rb is omitted here.

Next, the screen data creating section 123b calculates, based on the display avoidance area Rb calculated above and the display screen information 311 obtained above, an area (i) which is an area in the display screen other than the display avoidance area Rb and (ii) in which the partial book data is arranged (S2335). Then, the screen data creating section 123b lays out, based on the analysis data received from the analyzing section 121b, the partial book data in the area calculated above (S2336).

(Flow of Combining Process)

A process for generating combined data is the same as that explained in Embodiment 1 with reference to the flowchart shown in FIG. 7. Therefore, the process for generating combined data is omitted here. Note, however, that, in the present embodiment, the “screen data creating section 123b” is used instead of the “screen data creating section 123a” which is early described in the (Flow of Combining Process) explained with reference to the flowchart shown in FIG. 7.

### Embodiment 3

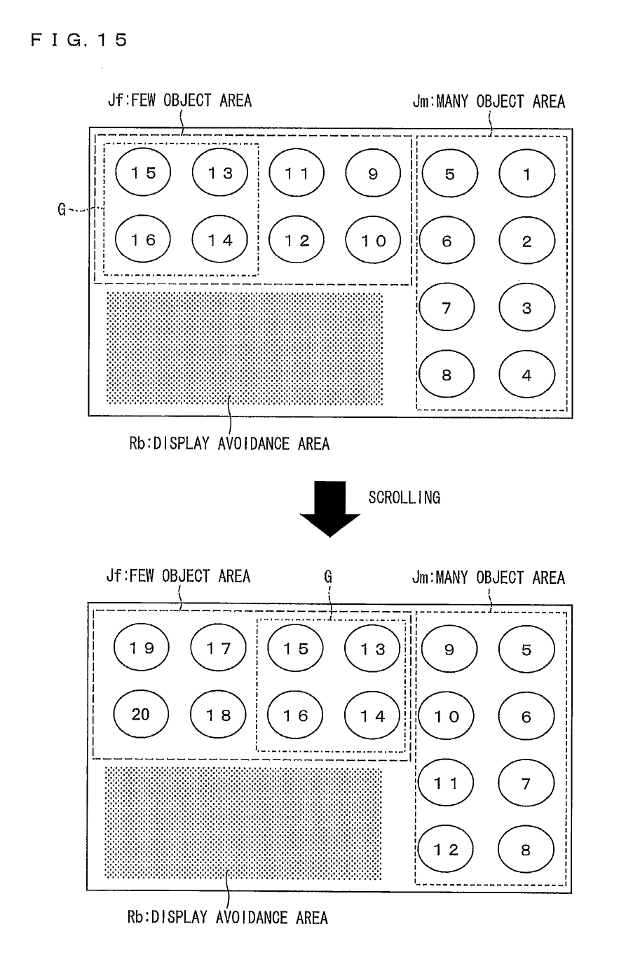

The following description will discuss yet another embodiment of the present invention with reference to FIG. 15.

The present embodiment discusses a configuration in which object sequence data is configured only by objects such as an image.

Note that the configurations of and the processes in the content display processing device 1 described in Embodiments 1 and 2 can be applied to the present embodiment by reading “characters” of Embodiments 1 and 2 as “objects”. On this account, in the present embodiment, explanations for configurations of and processes in the content display processing device 1 are omitted.

The following describes, with reference to FIG. 15, how objects are displayed when object sequence data, which is made up of only the objects such as an image, is scrolled with restriction of scroll amount.

Note that, in the example shown in FIG. 15, the object sequence data is assumed to be scrolled in a direction from left to right in FIG. 15. For convenience, in the description below, it is assumed that objects contained in the object sequence data are all the same kind of objects and are arranged in a longitudinal direction (vertical direction). Moreover, it is assumed that the objects contained in the object sequence data are displayed with a predetermined object size, a predetermined line spacing, and a predetermined object spacing, which will not be changed. Further, the display avoidance area Rb is assumed to have a rectangular shape.

In the example shown in FIG. 15, the display area has (i) an area (hereinafter, referred to as “many object area Jm”) in which four objects can be displayed per line and (ii) an area (hereinafter, referred to as “few object area Jf”) in which two objects can be displayed per line. Note that, in the example shown in FIG. 15, the many object area Jm corresponds to the “second area” recited in the claims of the subject application and the few object area Jf corresponds to the “first area” recited in the claims of the subject application.

In this case, (i) the number of objects (hereinafter, referred to as “the number γ of objects”) which can be displayed per line in the many object area Jm and (ii) the number of objects (hereinafter, referred to as “the number δ of objects”) which can be displayed per line in the few object area Jf are calculated based on the display screen information 311 and display avoidance area information.

Then, the number of lines in the many object area Jm, which number of lines corresponds to a least common multiple of the number γ of objects and the number δ of objects, is set to be a minimum unit of scroll amount.

The number of objects, which corresponds to the minimum unit of scroll amount obtained above, is a multiple of the number δ of objects. Therefore, objects in the few object area Jf, which objects will not be moved to the many object area Jm by the scrolling, will be moved only in the horizontal direction but will not be moved in the vertical direction. In the example shown in FIG. 15, the number γ of objects is four and the number δ of objects is two. In such a case, when the object sequence data is scrolled by four objects, which is a least common multiple of the number γ of objects and the number δ of objects, the objects indicated by an object sequence G in FIG. 15 are not moved in the vertical direction.

By the process above described, it is possible to prevent the objects, which are displayed in the few object area Jf before and after scrolling, from being moved in the vertical direction by the scrolling.

Note that, in a case where the display avoidance area Rb does not have the rectangular shape, the object sequence data may be scrolled by a minimum scroll amount of one (1) page, instead of being scrolled line by line.

In the example of FIG. 15, the display avoidance area Rb is located on lower left of the display area. However, the method for calculating the minimum unit of scroll amount above described can be applied to a case where the display avoidance area Rb is located at a different position in the display area.

In the above description, the objects contained in the object sequence data are all the same kind of objects. However, in a case where the object sequence data contains objects of different kinds, the objects may be adjusted in size and in display position, as with an object inserted into text data, which will be described in Embodiment 4 below.

### Embodiment 4

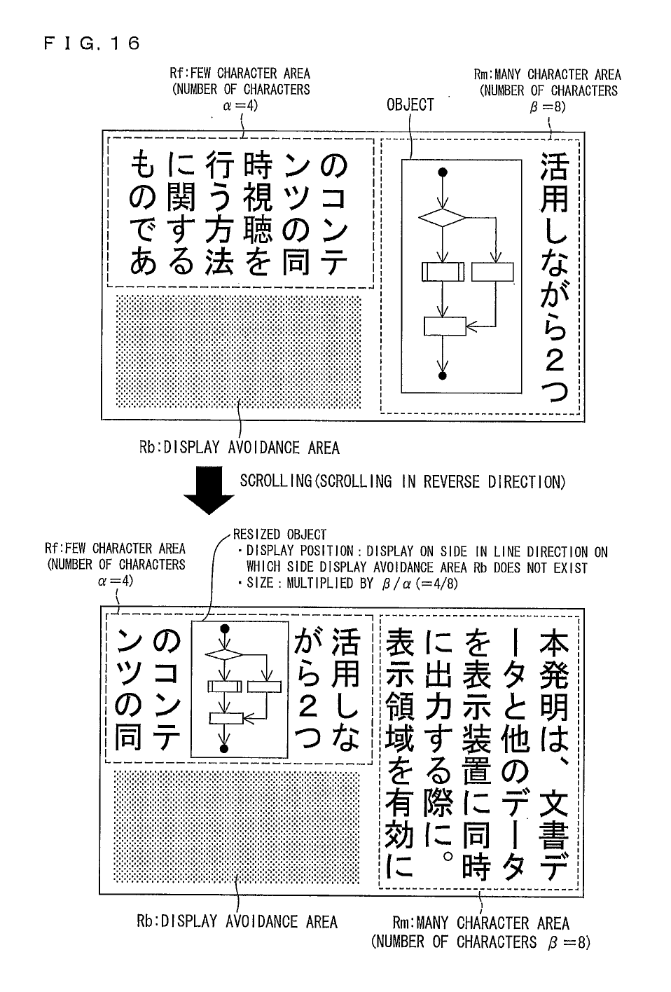

The following description will discuss still another embodiment of the present invention, with reference to FIGS. 16 through 20.

The present embodiment discusses a configuration in which object sequence data is made up of text data into which an object, which is not a character, is inserted between characters. Note that the object, which is not a character, is typically an image. However, the present embodiment is not limited to this, and any data can be employed, as long as the data can be controlled in display by specifying a display position and a size thereof. In the present embodiment, the object, which is not a character, is simply referred to as “object”.

In the present embodiment also, it is possible to employ the configurations of and the processes in the content display processing device 1 described in Embodiments 1 and 2. Therefore, in the present embodiment, explanations for configurations of and processes in the content display processing device 1 are omitted, and processes which are different from those in Embodiments 1 and 2 are described.

(Display Avoidance Area Information)

Display avoidance area information of the present embodiment contains information regarding a character part in text data, which information is similar to that of Embodiment 1. That is, the information regarding the character part in text data contains (A) pieces of information indicative of (i) a size of a blank image object which is to be provided in the display avoidance area Rb and (ii) a position in partial book data at which position the blank image object is to be inserted or (B) information indicative of a position at which a line feed is to be inserted. In brief, the information (A) is attribute information of the blank image object and the information (B) is attribute information of the line feed to be inserted. Moreover, in the present embodiment, the object, which is different from a character, needs to be displayed so as not to be displayed in the display avoidance area Rb. In view of this, the display avoidance area information of the present embodiment is assumed to further contain (i) resizing information for adjusting a size of the object and (ii) display position information for adjusting a display position of the object, with which the display avoidance area Rb is calculated.

(Scroll Amount Control)

With regard to control of scroll amount of the text data, the number of lines of the many character area Rm, which number of lines corresponds to a least common multiple of the number α of characters and the number β of characters, is set to a minimum unit of scroll amount, as with Embodiment 1.

Next, in a case where the object, which has been inserted into the text data, overlaps the display avoidance area Rb if the object is arranged with a predetermined size and at a predetermined display position, the object is adjusted in size and in display position. The object can be adjusted in size and in display position in the following method (1) or (2): (1) a method in which (i) the size of the object is resized into β/α of the predetermined size and (ii) the object, which has been thus resized, is displayed on a side in a line direction on which side the display avoidance area Rb does not exist (for example, in a case where the text data is vertically written and the display avoidance area Rb is positioned on lower left of the screen, the object is positioned on upper side of the screen or, in a case where the text data is horizontally written and the display avoidance area Rb is positioned on lower right of the screen, the object is positioned on left side of the screen) or (2) a method in which (i) the predetermined display position of the object is employed and (ii) the object is resized into a maximum size with which the object at the predetermined display position does not overlap the display avoidance area Rb.

FIG. 16 illustrates an example in which the object is adjusted in size and in display position with the use of the above method (1). FIG. 16 illustrates a state where the object sequence data is scrolled in a direction from right to left in FIG. 16. As shown in FIG. 16, the object displayed after scrolling (i) is positioned on an side (i.e., on an upper side of the screen) in the line direction on which side the display avoidance area Rb does not exist and (ii) is resized into β/α (=4/8) of the predetermined size of the object.

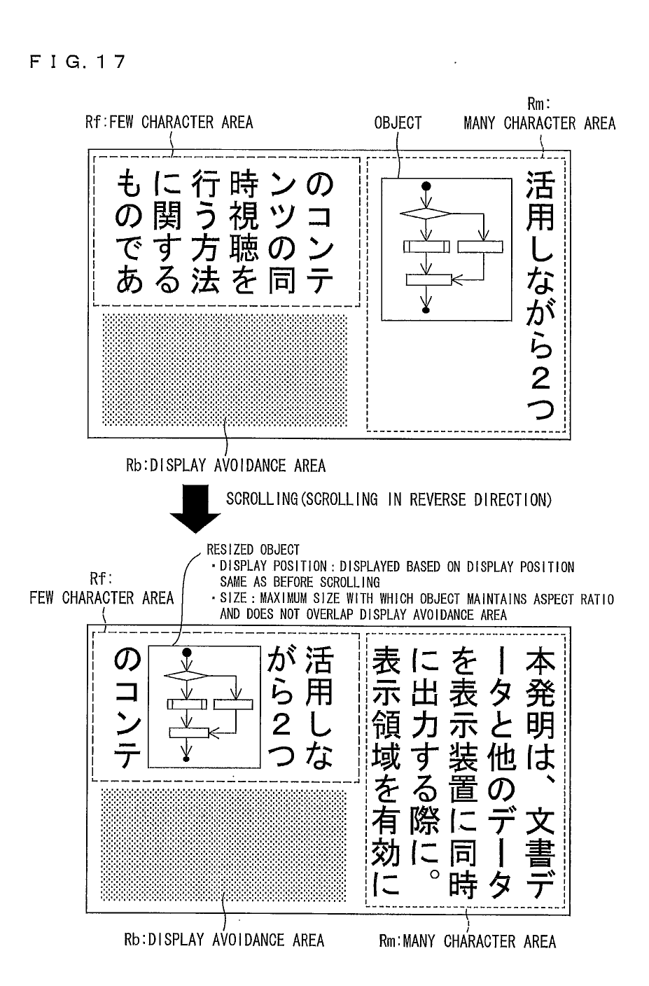

FIG. 17 illustrates an example in which the object is adjusted in size and in display position with the use of the above method (2). FIG. 17 illustrates a state where the object sequence data is scrolled in a direction from right to left in FIG. 17. As shown in FIG. 17, the object displayed after scrolling (i) is positioned based on the predetermined display position (in this case, an upper right point of the object is specified) which has not been changed and (ii) is resized to have a maximum size with which the object does not overlap the display avoidance area Rb.

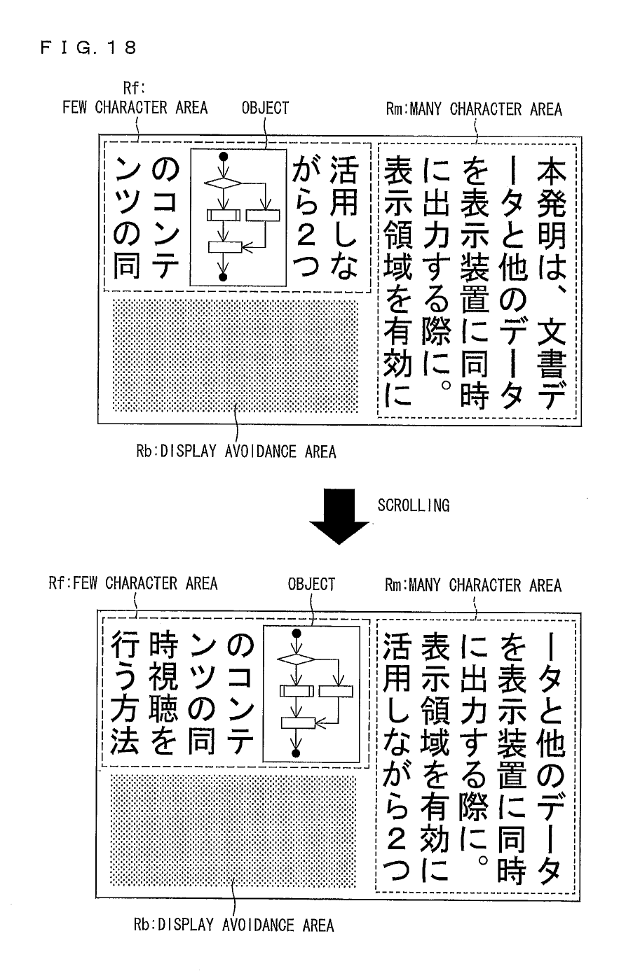

The object is scrolled by a scroll amount which has been set based on the text data, provided that the object (i) is displayed in the many character area Rm before and after scrolling by the scroll amount set based on the text data or (ii) is displayed in the few character area Rf before and after scrolling by the scroll amount set based on the text data. FIG. 18 illustrates such a state. As shown in FIG. 18, the object has the same size before and after the scrolling.

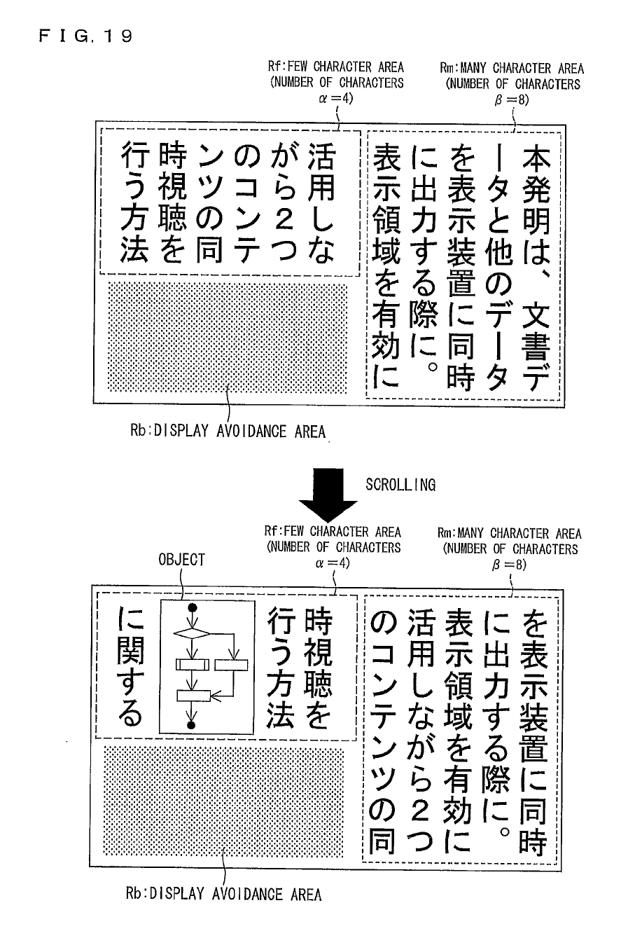

On the other hand, in a case where an object, which has not been displayed before s crolling, appears after the scrolling, the scrolling is made by the number of lines of the many character area Rm which number (i) is not less than a scroll amount by which an entire resized object can be displayed and (ii) corresponds to the number of characters which is a common multiple of the number α of characters and the number β of characters. FIG. 19 illustrates such a state. As shown in FIG. 19, the object is displayed, after the scrolling, in a part of the few character area Rf which part corresponds to three lines of the few character area Rf, as a result of the scrolling made by two lines of the many character area Rm (in other words, by four lines of the few character area Rf), which two lines correspond to 16 characters which is a common multiple of the number α of characters (=4) and the number β of characters (=8).

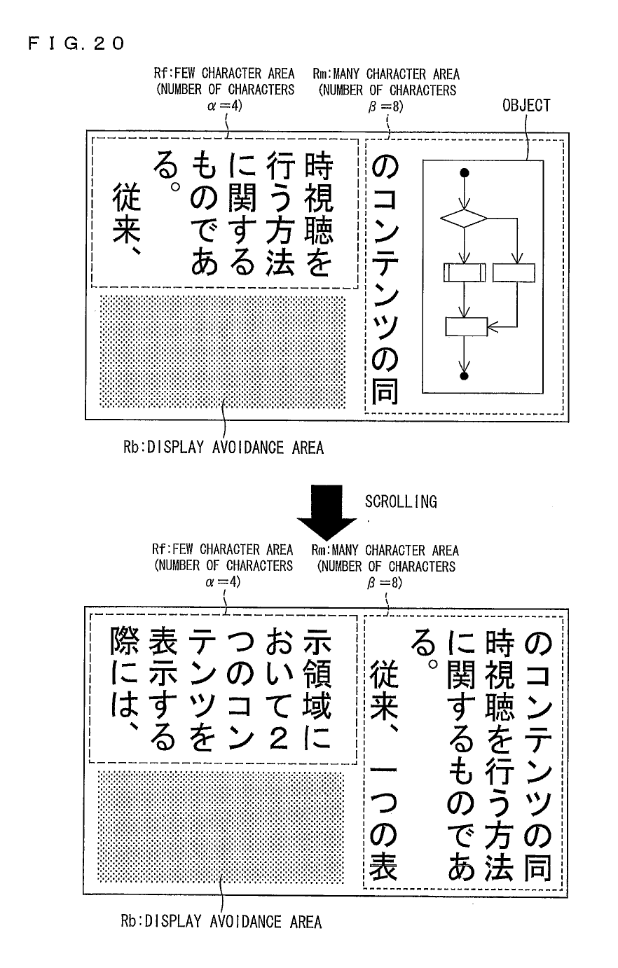

Alternatively, in a case where an object, which has been displayed before scrolling, disappears after the scrolling, the scrolling is made by the number of lines of the many character area Rm which number (i) is not less than the number of lines by which a line following the object is moved to the starting point in the display area and (ii) corresponds to the number of characters which is a common multiple of the number α of characters and the number β of characters. FIG. 20 illustrates such a state. As shown in FIG. 20, the object is displayed, before the scrolling, in a part of the many character area Rm which part corresponds to four lines of the many character area Rm. Then, the scrolling is made by four lines of the many character area Rm, which four lines correspond to 32 characters which is a common multiple of the number α of characters (=4) and the number β of characters (=8).

### Embodiment 5

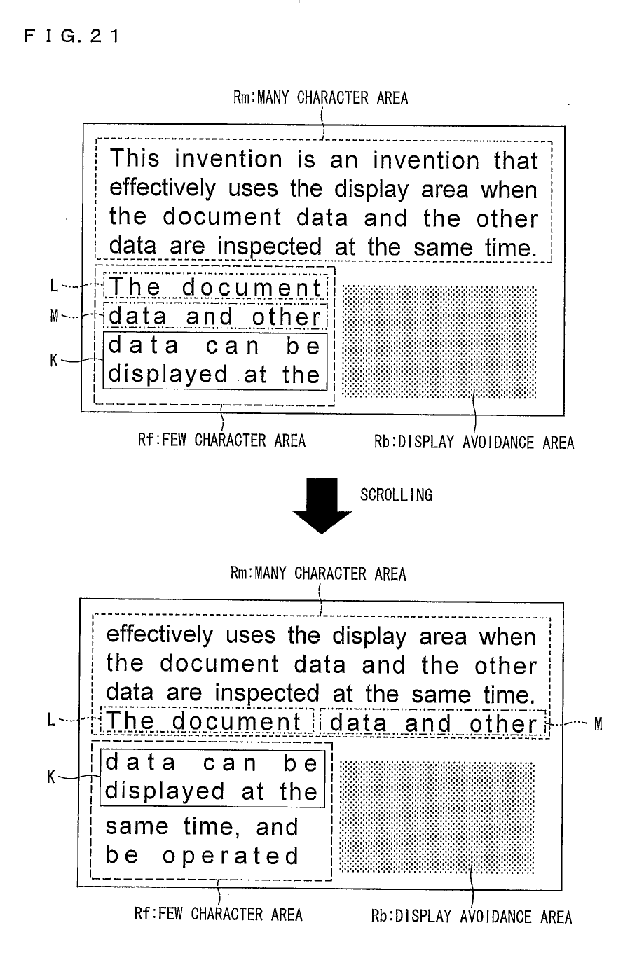

The following description will discuss still another embodiment of the present invention, with reference to FIG. 21.

The present embodiment discusses a configuration in which the electronic book data (object sequence data) is text data of an English sentence (alphabetic characters). In the present embodiment, it is assumed that the alphabetic characters contained in the electronic book data are arranged, in a lateral direction (horizontal direction), in the display area. It is assumed that the text data is controlled such that one word is not to be displayed across two lines.

In the present embodiment, it is possible to employ the configurations of and the processes in the content display processing device 1 which are explained in the early described Embodiments. Note, however, that, with regard to display controls carried out by the display control sections 133a and 133b, points (A) through (C) below are different from the early described Embodiments.

(A) In the present embodiment, words displayed per line are determined based on a length of each line and a width of each of the words, in order that one word, which is made up of a plurality of characters, is not displayed across two lines. Specifically, (i) words are sequentially displayed from the beginning of a line and (ii) widths of the respective displayed words and a width of spacing between each adjacent two of the displayed words are all summed up. Then, in a case where the length of the line is exceeded if a next word is added to the summation, that next word is not displayed in that line but is displayed in a next line. Note that a width of a word is calculated by summing widths of respective characters contained in the word. The words displayed per line can be arranged by left justification, right justification, center justification, both end justification in a unit of character, or both end justification in a unit of word. Note, however, that the present embodiment is not limited to those arrangements.

(B) A minimum unit of scroll amount is the number of lines of the many character area Rm which corresponds to a least common multiple of a length of each line of the many character area Rm and a length of each line of the few character area Rf.

(C) Words, which are moved from the few character area Rf to the many character area Rm by the scrolling, are moved to the many character area Rm while the words maintain respective widths thereof and a width of spacing between each adjacent two of the words. In this case, a display condition before the scrolling is required for carrying out the above control. In view of this, the display condition before the scrolling is obtained by a simulation. Note that the display condition before the scrolling does not necessarily obtained by the simulation, but the content display processing device 1 may have a function to store the display condition before the scrolling.

The following description discusses, with reference to FIG. 21, an example of a scroll amount by which the electronic book data of the present embodiment is scrolled. FIG. 21 is a schematic view illustrating how characters are displayed when the electronic book data is scrolled with a restricted scroll amount. Note that, in the example shown in FIG. 21, the electronic book data is scrolled in a direction from a lower side to an upper side of FIG. 21. For convenience of explanation, it is assumed that characters contained in the electronic book data are displayed with a predetermined character size, a predetermined line spacing, and a predetermined character spacing, which will not be changed. Further, the display avoidance area Rb is assumed to have a rectangular shape.

In the example shown in FIG. 21, (i) each character is depicted in line width of one (1) dot, (ii) each line of the many character area Rm has a length of 182 dots, and (iii) each line of the few character area Rf has a length of 96 dots. In this case, the electronic book data is scrolled by one (1) line of the many character area Rm which one (1) line corresponds to 182 dots, which is a least common multiple of the length of the each line of the many character area Rm (182 dots) and the length of the each line of the few character area Rf (96 dots). With the configuration, the characters, indicated by a character string K in the few character area Rf in FIG. 21, do not move in the horizontal direction.

Note that, as shown in FIG. 21, the words indicated by character strings L and M are moved from the few character area Rf to the many character area Rm by the scrolling while the words maintain, before and after the scrolling, the respective widths thereof and the width of spacing between each adjacent two of the words.

### Effects of Present Invention

In order to attain the object, a display processing device of the present invention includes a display control section configured to control a display section to display, on a display area of the display section, character string data which is selected out of text data by a display target range which moves in order of characters contained in the text data, the character string data being displayed in accordance with the move of the display target range, and the display control section setting, in the display area, a display avoidance area in which the character string data is not displayed.

Moreover, a method of the present invention for controlling a display processing device includes the step of: (a) causing a display area of a display section to display character string data which is selected out of text data by a display target range which moves in order of characters contained in the text data, the step (a) including causing the display section to display in the display area the character string data in accordance with the move of the display target range, and causing the display section to set in the display area a display avoidance area in which the character string data is not displayed.

With the configuration, the character string data, which is selected by the display target range which moves (so that the text data is scrolled) in the order of the characters contained in the text data, can be displayed in the display area of the display section. Moreover, the display area has the display avoidance area in which the character string data is not displayed.

With the configuration, the character string data is displayed in an area in the display area other than the display avoidance area. That is, the text data can be scrollably displayed in the area (non-rectangular shape area) in the display area other than the display avoidance area.

For example, in a case where non-text data (e.g., video data) is displayed in the display avoidance area simultaneously with text data being displayed in the area other than the display avoidance area, the configuration of the present invention allows the user to go on reading the text data by scrolling the text data while viewing the non-text data.

This brings about an effect of improving convenience of the user who continues reading the text data by scrolling the text data.

The display processing device of the present invention further may include adding means for adding, to the text data, display avoidance area information based on which the display control section sets the display avoidance area in the display area, the display control section setting the display avoidance area based on the display avoidance area information which has been added to the text data by the adding means.

According to the configuration, the display avoidance area information is added to the text data, and the display avoidance area is set in accordance with the display avoidance area information thus added.

With the configuration, the display control section can carry out display of the text data by using a function of a general-use application program, a general-use module, or the like with which the text data can be displayed.

On this account, the user does not need to newly introduce (install) an application program, a module, or the like for viewing the text data while scrolling the text data. This brings about an effect of improving convenience of the user.

The display processing device of the present invention may further include: a storage section configured to store area information indicative of a non-text display area in which a non-text content is displayed, the non-text display area being provided in the display area, the display control section setting the display avoidance area based on the area information stored in the storage section.

According to the configuration, the display avoidance area is set in accordance with the area information stored in the storage section.

With the configuration, the text data can be scrollably displayed in the area other than the display avoidance area, without subjecting the text data to any special process.

This brings about an effect of suppressing an increase in processing load for processing the text data.

In the display processing device of the present invention, it is possible that the display area has a non-text display area in which a non-text content is displayed; and the display control section sets, in the display area, the display avoidance area such that the display avoidance area entirely encompasses the non-text display area.

According to the configuration, the display avoidance area is set to entirely encompass the non-text display area.

Here, in the text data, a character size, a line spacing, a character spacing, and the like are sometimes nonuniform. For example, a character string corresponding to a heading often has a larger character size. This sometimes causes a change, when the text data is scrolled, in arrangement of the displayed characters.

In a case where the display position of the display avoidance area is determined simply based on the positions at which the characters are displayed, the display position of the display avoidance area is sometimes changed in accordance with a change in the positions at which the characters are displayed. As a result, the non-text display area sometimes partially goes outside of the display avoidance area, and accordingly, the text data may be displayed in the part of the non-text display area.

In order to deal with the above phenomenon, in the present invention, the display avoidance area is set to entirely encompass the non-text display area. This makes it possible to prevent the non-text display area from partially going outside of the display avoidance area, even though the display position of the display avoidance area is changed.

It is therefore possible to prevent the non-text content and the text data from being displayed while overlapping each other, after the text data is scrolled. This makes it possible to maintain a state where both the non-text content and the text data are constantly easily viewed. This brings about an effect of improving visibility for the user.

In the display processing device of the present invention, it is possible that the display avoidance area calculating means calculates (a) a horizontal length of the display avoidance area based on (i) a horizontal length of the non-text display area and (ii) a character size and a line spacing with which the text data is displayed and (b) a vertical length of the display avoidance area based on (i) a vertical length of the non-text display area and (ii) the character size and a character spacing with which the text data is displayed.

According to the configuration, the display avoidance area calculating means can calculates the display avoidance area based on (i) the area information and (ii) the character size, the line spacing, and the character spacing, of the characters contained in the text data. This makes it possible to prevent the non-text display area from partially going outside of the display avoidance area, even though the character size, the line spacing, the character spacing, and the like of the characters contained in the text data are changed by the scrolling and accordingly the display position of the display avoidance area is changed.

Moreover, according to the configuration of the present invention, the display avoidance area is calculated based on the above described pieces of information. This makes it possible to avoid a case where the display avoidance area is set to be larger than necessary so that the display avoidance area entirely encompasses the non-text display area.

The display processing device of the present invention may further include non-text content obtaining means for obtaining the non-text content, the display control section controlling the display section to display, in the non-text display area, the non-text content which has been obtained by the non-text content obtaining means.

According to the configuration, the non-text content, which has been obtained, can be displayed in the non-text display area.

With the configuration, the non-text content is displayed in the non-text display area and the text data is scrollably displayed in the area other than the display avoidance area.

It is therefore possible to effectively utilize the entire display area, as compared with the prior art (early described in Background Art) in which the display area is divided lengthwise or crosswise into two areas. This brings about an effect of improving visibility for the user.

In the display processing device of the present invention, it is possible that, when the display control section causes the display section to display the character string data in such a manner that characters contained in the character string data are moved from a first area, in which a first number of characters are displayed per line, to a second area, in which a second number of characters, which is different from the first number of characters, are displayed per line, the display control section causes the display section to display the character string data in such a manner that (i) a predetermined number of line(s) of a character string starting from a second area side part in the first area is(are) moved to a first area side part in the second area and (ii) a character string, which follows the predetermined number of line(s) of the character string, is moved to the second area side part in the first area.

According to the configuration, the characters contained in the character string, which follows the character string moved to the area in which the different number of characters can be displayed, can be moved (scrolled) to the second area side part in the first area while maintaining their vertical display positions.

That is, the characters contained in the lines, which are moved (scrolled) in the first area, can maintain their display positions in a direction perpendicular to a direction in which the character string data is moved. For example, in a case where the lines are moved in the horizontal direction by scrolling, the vertical display positions of the characters can be maintained.

This allows the user to easily view the characters contained in the lines which are moved (scrolled) in the first area by scrolling. This brings about an effect of improving visibility for the user.

In the display processing device of the present invention, it is possible that the predetermined number of line(s) is the number of line(s) in which a third number of characters are displayed, the third number of characters being a least common multiple of the first number of characters and the second number of characters.

According to the configuration, a minimum unit of scrolled lines is set to the number of lines which contain the number of characters which is the least common multiple of (i) the number of characters which can be displayed per line in the first area and (ii) the number of characters which can be displayed per line in the second area. This allows the character string data to be scrolled while the display positions of the characters are maintained and to be scrolled by the small number of lines. It is therefore possible to improve operability and visibility for the user.

The display processing device of the present invention may further include switching means for causing, in response to a predetermined trigger, the display control section to switch whether or not to provide the display avoidance area in the display area.

According to the configuration, whether or not the display avoidance area is provided in the display area can be switched by the predetermined trigger.

Here, in a case where the display avoidance area is set not to be provided in the display area, the text data will be displayed in the entire display area.

That is, it is possible to switch whether (i) the text data is displayed in the entire display area or (ii) the text data is displayed in the area of the display area other than the display avoidance area.

Note that the predetermined trigger can be, for example, a user's operation of remote controller. In a case where the user wants to view only the text data without viewing the non-text content, the user can set the display as such by operating a remote controller, or the like.

In order to attain the object, a display processing device of the present invention includes: a display control section configured to control a display section to display, on a display area of the display section, an object sequence which is selected out of object sequence data by a display target range which moves in order of a plurality of objects contained in the object sequence data, the object sequence being displayed in accordance with the move of the display target range, and the display control section setting, in the display area, a display avoidance area in which the object sequence, which is selected by the display target range, is not displayed.

Moreover, a method of the present invention for controlling a display processing device includes the step of: (a) causing a display area of a display section to display an object sequence which is selected out of object sequence data by a display target range which moves in order of a plurality of objects contained in the object sequence data, the step (a) including causing the display section to display in the display area the object sequence in accordance with the move of the display target range, and causing the display section to set in the display area a display avoidance area in which the object sequence is not displayed.

According to the configuration, the display area of the display section can be controlled to display the object sequence, which is selected by the display target range which is moved in the predetermined order of the plurality of objects constituting the object sequence data (such that the object sequence data is scrolled). Moreover, the display area has the display avoidance area in which the object sequence, which is selected by the display target range, is not displayed.

With the configuration, the object sequence, which is selected by the display target range, is displayed in an area in the display area other than the display avoidance area. That is, the object sequence data can be scrollably displayed in the area (non-rectangular shaped area) in the display area other than the display avoidance area.

For example, in a case where data (e.g., video data), which is different from the object sequence data, is displayed in the display avoidance area simultaneously with text data (as the object sequence data) being displayed in the area other than the display avoidance area, the configuration of the present invention allows the user to go on reading the text data by scrolling the text data while viewing the video data.

This brings about an effect of improving convenience of the user who continues viewing the object sequence data by scrolling the object sequence data.

The display processing device of the present invention may further include adding means for adding, to the object sequence data, display avoidance area information based on which the display control section sets the display avoidance area in the display area, the display control section setting the display avoidance area based on the display avoidance area information which has been added to the object sequence data by the adding means.

According to the configuration, the display avoidance area information is added to the object sequence data, and the display avoidance area is set in accordance with the display avoidance area information thus added.

With the configuration, the display control section can carry out display of the object sequence data by using a function of a general-use application program, a general-use module, or the like with which the object sequence data can be displayed. For example, a function of a Web browser or the like can be used.

On this account, the user does not need to newly introduce (install) an application program, a module, or the like for viewing the object sequence data while scrolling the object sequence data. This brings about an effect of improving convenience of the user.

The display processing device of the present invention may further include a storage section configured to store area information indicative of a non-object-sequence display area in which a content, which is different from the object sequence data, is displayed, the non-object-sequence display area being provided in the display area, the display control section setting the display avoidance area based on the area information stored in the storage section.

According to the configuration, the display avoidance area is set in accordance with the area information stored in the storage section.

With the configuration, the object sequence data can be scrollably displayed in the area other than the display avoidance area, without subjecting the object sequence data to any special process.

This brings about an effect of suppressing an increase in processing load for processing the object sequence data.

In the display processing device of the present invention, it is possible that the display area has a non-object-sequence display area in which a content, which is different from the object sequence data, is displayed; and the display control section sets, in the display area, the display avoidance area such that the display avoidance area entirely encompasses the non-object-sequence display area.

According to the configuration, the display avoidance area is set to entirely encompass the non-object-sequence display area.

Here, in the object sequence data, an object size, a line spacing, an object spacing, and the like are sometimes nonuniform. For example, a character string corresponding to a heading often has a larger character size. This sometimes causes a change, when the object sequence data is scrolled, in arrangement of the displayed characters.

In a case where the display position of the display avoidance area is determined simply based on the positions at which the objects are displayed, the display position of the display avoidance area is sometimes changed in accordance with a change in the positions at which the objects are displayed. As a result, the non-object-sequence display area sometimes partially goes outside of the display avoidance area, and accordingly, the text data may be displayed in the part of the non-object-sequence display area.

In order to deal with the above phenomenon, in the present invention, the display avoidance area is set to entirely encompass the non-object-sequence display area. This makes it possible to prevent the non-object-sequence display area from partially going outside of the display avoidance area, even though the display position of the display avoidance area is changed.

It is therefore possible to prevent the content, which is different from the object sequence data, and the object sequence data from being displayed while overlapping each other, after the object sequence data is scrolled. This makes it possible to maintain a state where both the content, which is different from the object sequence data, and the object sequence data are constantly easily viewed. This brings about an effect of improving visibility for the user.

In the display processing device of the present invention, it is possible that the display avoidance area calculating means calculates (a) a horizontal length of the display avoidance area based on (i) a horizontal length of the non-object-sequence display area and (ii) an object size and a line spacing with which the object sequence data is displayed and (b) a vertical length of the display avoidance area based on (i) a vertical length of the non-object-sequence display area and (ii) the object size and an object spacing with which the object sequence data is displayed.

According to the configuration, the display avoidance area calculating means can calculates the display avoidance area based on (i) the area information and (ii) the object size, the line spacing, and the object spacing, of the objects contained in the object sequence data. This makes it possible to prevent the non-object-sequence display area from partially going outside of the display avoidance area, even though the display position of the display avoidance area is changed because the object size, the line spacing, the object spacing, and the like of the objects contained in the object sequence data are changed by the scrolling.

Moreover, according to the configuration of the present invention, the display avoidance area is calculated based on the above described pieces of information. This makes it possible to avoid a case where the display avoidance area is set to be larger than necessary so that the display avoidance area entirely encompasses the non-object-sequence display area.

The display processing device of the present invention may further include non-object-sequence obtaining means for obtaining the content which is different from the object sequence data, the display control section controlling the display section to display, in the non-object-sequence display area, the content which has been obtained by the non-object-sequence obtaining means.

According to the configuration, it is possible to obtain the content which is different from the object sequence data and to display the content in the non-object-sequence display area.

With the configuration, the content, which is different from the object sequence data, is displayed in the non-object-sequence display area and the object sequence data is scrollably displayed in the area other than the display avoidance area.

It is therefore possible to effectively utilize the entire display area, as compared with the prior art (early described in Background Art) in which the display area is divided lengthwise or crosswise into two areas. This brings about an effect of improving visibility for the user.

In the display processing device of the present invention, it is possible that, when the display control section causes the display section to display the object sequence data in such a manner that objects contained in the object sequence are moved from a first area, in which a first number of objects are displayed per line, to a second area, in which a second number of objects, which is different from the first number of objects, are displayed per line, the display control section causes the display section to display the object sequence data in such a manner that (i) a predetermined number of line(s) of an object sequence from a second area side part in the first area is(are) moved to a first area side part in the second area and (ii) an object sequence, which follows the predetermined number of line(s) of the object sequence, is moved to the second area side part in the first area.

According to the configuration, the objects contained in the object sequence, which follows the object sequence moved to the area in which the different number of characters can be displayed, can be moved (scrolled) to the second area side part in the first area while maintaining their vertical display positions.

That is, the objects contained in the lines, which are moved (scrolled) in the first area, can maintain their display positions in a direction perpendicular to a direction in which the object sequence data is moved. For example, in a case where the lines are moved in the horizontal direction by scrolling, the vertical display positions of the objects can be maintained.

This allows the user to easily view the objects contained in the lines which are moved (scrolled) in the first area by scrolling. This brings about an effect of improving visibility for the user.

In the display processing device of the present invention, it is possible that the predetermined number of line(s) is the number of line(s) in which a third number of objects are displayed, the third number of objects being a least common multiple of the first number of objects and the second number of objects.

According to the configuration, a minimum unit of scrolled lines is set to the number of lines which contain the number of objects which is the least common multiple of (i) the number of objects which can be displayed per line in the first area and (ii) the number of objects which can be displayed per line in the second area. This allows the object sequence data to be scrolled while the display positions of the objects are maintained and to be scrolled by the small number of lines. It is therefore possible to improve operability and visibility for the user.

The display processing device of the present invention may further include switching means for causing, in response to a predetermined trigger, the display control section to switch whether or not to provide the display avoidance area in the display area.

According to the configuration, whether or not the display avoidance area is provided in the display area can be switched by the predetermined trigger.

Here, in a case where the display avoidance area is set not to be provided in the display area, the object sequence data will be displayed in the entire display area.

That is, it is possible to switch whether (i) the object sequence data is displayed in the entire display area or (ii) the object sequence data is displayed in the area of the display area other than the display avoidance area.

Note that the predetermined trigger can be, for example, a user's operation of remote controller. In a case where the user wants to view only the object sequence data without viewing the content which is different from the object sequence data, the user can set the display as such by operating a remote controller, or the like.

Note that the display processing device can be realized by a computer. In such a case, the present invention encompasses (i) a control program of the display processing device which causes the computer to serve as the means of the display processing device and (ii) a computer-readable storage medium which stores the control program.

Embodiments, other than those early described, of the present invention can be expressed as follows.

[1]A display processing device of the present invention may include: an analyzing section which analyzes first content data; a screen data creating section which lays out, based on display screen information, the first content data analyzed by the analyzing section; a layout prohibiting area calculating section (i) which is provided so as to be followed by the analyzing section and (ii) which calculates an area in the first content data which area corresponds to layout prohibiting area information for specifying an area in which the layout of the first content data is prohibited; and a data processing section which rewrite the first content data based on a result of the calculation carried out by the layout prohibiting area calculating section.

[2]A display processing device of the present invention may include: an analyzing section which analyzes first content data; a screen data creating section which lays out, based on display screen information, the first content data analyzed by the analyzing section, the screen data creating section having a function to lay out the first content data such that the first content data is not laid out in an area specified by layout prohibiting area information which specifies the area in which the layout of the first content data is prohibited.

The display processing device of the present invention may include: a sub-information obtaining section which obtains second content data; a combining section which combines (i) an output (not limited to one which requires to be decoded) of the screen data creating section and (ii) the second content data obtained by the sub-information obtaining section, the combining section combining the output with the second content data by providing the second content data in the area specified by the layout prohibiting area information.

[4] The display processing device of the present invention may include a switching section which controls whether or not to rewrite the first content data by the data processing section.

[5] In the display processing device of the present invention, the first content data may be document data.

[6] The display processing device of the present invention may include a control input information processing section which restricts a minimum movement amount of the document data which is scrolled.

[7] In the display processing device of the present invention: an area in which a layout of the document data is prohibited may be calculated based on any one of or two or more of a character size, a line spacing, a character spacing, and an indent, of the document data and layout prohibiting area information; and the area in which the second content data is displayed may be maintained in a fixed position with respect to an entire display area, without being affected by any one of or two or more of the character size, the line spacing, the character spacing, and the indent, of the document data.

[Additional Remark]

Lastly, blocks of the content display processing device 1a and the content display processing device 1b, in particular, the main control section 100a and the main control section 100b, each can be configured by hardware logic or realized by software with the use of CPU as follows.

That is, the content display processing device 1 includes a CPU (central processing unit), a ROM (read only memory), a RAM (random access memory), and a storage device (storage medium) such as a memory. The CPU executes instructions of control programs for realizing the functions of the content display processing device 1. In the ROM, the programs are stored. Into the RAM the programs are loaded. In the storage device, the programs and various data are stored. The objective of the present invention can also be achieved, by (i) supplying a storage medium, in which program codes (executable programs, intermediate code programs, source programs) of programs for controlling the content display processing device 1 configured by software for realizing the functions, are stored so that a computer can read them, to the content display processing device 1, and then (ii) causing the computer (or CPU or MPU) to read and execute the program codes stored in the storage medium.

The storage medium can be, for example, a tape, such as a magnetic tape or a cassette tape; a disk including (i) a magnetic disk such as a Floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM, or flash ROM.

Alternatively, content display processing device 1 can be arranged to be connected to a communications network so that the program codes are delivered over the communications network. The communications network is not limited to a specific one, and therefore can be, for example, the Internet, an intranet, extranet, LAN, ISDN, VAN, CATV communications network, virtual private network, telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR (high data rate), mobile telephone network, satellite line, or terrestrial digital network. Note that, the present invention can be realized by a computer data signal (i) which is realized by electronic transmission of the program code and (ii) which is embedded in a carrier wave.

As above described in this specification, the term “means” does not necessarily indicates a physical means. Therefore, functions of the means may be realized by software. Further, a function of one of the means may be realized by two or more physical means. Alternatively, functions of two or more of the means may be realized by one (1) physical means.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention can be applied to a display processing device which carries out a content display process.

In particular, the present invention is suitable for use in a display processing device which carries out a process for simultaneously displaying text data and non-text data.

Moreover, the present invention is suitable for use in a display processing device which carries out a process for simultaneously displaying (i) data (e.g., text data) configured by a plurality of objects arranged in a predetermined order and (ii) data (e.g., an image) which is different from object sequence data.

### REFERENCE SIGNS LIST

1: Content display processing device (display processing device)
1a: Content display processing device (display processing device)
1b: Content display processing device (display processing device)
100a: Main control section
100b: Main control section
115a: Scroll amount calculating section
115b: Scroll amount calculating section
117: Display avoidance area calculating section (display avoidance area calculating means)
119: Data processing section (adding means)
121a: Analyzing section
121b: Analyzing section
123a: Screen data creating section
123b: Screen data creating section (adding means, display avoidance area calculating means)
125: Combining section
127: Switching section (switching means)
129: Sub-information obtaining section (non-text content obtaining means, non-object-sequence obtaining means)
133a: Display control section
133b: Display control section
300: Storage section
313: Non-object-sequence area information (area information)
Rb: Display avoidance area
Rf: Few character area (first area, second area)
Rm: Many character area (second area, first area)
Jf: Few object area (first area, second area)
Jm: Many object area (second area, first area)
Rn: Non-object-sequence area (non-text display area, non-object-sequence display area)
α: The number of characters
β: The number of characters
γ: The number of objects
δ: The number of objects

1. A display processing device comprising:
a display control section configured to control a display section to display, on a display area of the display section, character string data which is selected out of text data by a display target range which moves in order of characters contained in the text data, the character string data being displayed in accordance with the move of the display target range, the display area having a non-text display area in which non-text content is displayed; a display avoidance area and a calculating section for calculating a display avoidance area which entirely encompasses the non-text display area,
the display control section setting, in the display area, the display avoidance area which has been calculated by the display avoidance area calculating section in which the character string data is not displayed.

2. The display processing device as set forth in claim 5,
further comprising:
adding means for adding, to the text data, display avoidance area information based on which the display control section sets the display avoidance area in the display area,
the display control section setting the display avoidance area based on the display avoidance area information which has been added to the text data by the adding means.

3. The display processing device as set forth in claim 5,
further comprising:
a storage section configured to store area information indicative of a non-text display area in which a non-text content is displayed, the non-text display area being provided in the display area,
the display control section setting the display avoidance area based on the area information stored in the storage section.

4. (canceled)

5. The display processing device as set forth in claim 1,
wherein:
the display avoidance area calculating means calculates (a) a horizontal length of the display avoidance area based on (i) a horizontal length of the non-text display area and (ii) a character size and a line spacing with which the text data is displayed and (b) a vertical length of the display avoidance area based on (i) a vertical length of the non-text display area and (ii) the character size and a character spacing with which die text data is displayed.

6. The display processing device as set forth in claim 5,
further comprising:
non-text content obtaining means for obtaining the non-text content,
the display control section controlling the display section to display, in the non-text display area, the non-text content which has been obtained by the non-text content obtaining means.

7. The display processing device as set forth in claim 5, wherein:
when the display control section causes the display section to display the character string data in such a manner that characters contained in the character string data are moved from a first area, in which a first number of characters are displayed per line, to a second area, in which a second number of characters, which is different from the first number of characters, are displayed per line,
the display control section causes the display section to display the character string data in such a manner that (i) a predetermined number of line(s) of a character string starling from a second area side part in the first area is(are) moved to a first area side part in the second area and (ii) a character string, which follows the predetermined number of line(s) of the character string, is moved to the second area side part in the first area.

8. The display processing device as set forth in claim 7, wherein:
the predetermined number of line(s) is the number of line(s) in which a third number of characters are displayed, the third number of characters being a least common multiple of the first number of characters and the second number of characters.

9. The display processing device as set forth in claim 5, further comprising:
switching means for causing, in response to a predetermined trigger, the display control section to switch whether or not to provide the display avoidance area in the display area.

10. (canceled)

11. A control program by which a computer, which is included in a display processing device recited in claim 5, is operated,
said control program causing the computer to serve as the means of the display processing device.

12. A computer-readable storage medium in which a control program recited in claim 11 is stored.

13. A display processing device comprising:
a display control section configured to control a display section to display, on a display area of the display section, an object sequence which is selected out of object sequence data by a display target range which moves in order of a plurality of objects contained in the object sequence data, the object sequence being displayed in accordance with the move of the display target range, and
the display area having a non-object-sequence display area in which content, which is different from the object sequence data, is displayed;
a display avoidance area which entirely encompasses the non-object-sequence display area;
said display processing device further comprises display avoidance area calculating means for calculating the display avoidance area which entirely encompasses the non-object-sequence display area; and
the display control section setting, in the display area, a display avoidance area which has been calculated by the display avoidance area calculating section in which the object sequence, which is selected by the display target range, is not displayed.

14. The display processing device as set forth in claim 17, further comprising:
adding means for adding, to the object sequence data, display avoidance area information based on which the display control section sets the display avoidance area in the display area,
the display control section setting the display avoidance area based on the display avoidance area information which has been added to the object sequence data by the adding means.

15. The display processing device as set forth in claim 17, further comprising:
a storage section configured to store area information indicative of a non-object-sequence display area in which a content, which is different from the object sequence data, is displayed, the non-object-sequence display area being provided in the display area,
the display control section setting the display avoidance area based on the area in formation stored in the storage section.

16. (canceled)

17. The display processing device as set forth in claim 13, wherein;
the display avoidance area calculating means calculates (a) a horizontal length of the display avoidance area based on (i) a horizontal length of the non-object-sequence display area and (ii) an object size and a line spacing with which the object sequence data is displayed and (b) a vertical length of the display avoidance area based on (i) a vertical length of the non-object-sequence display area and (ii) the object size and an object spacing with which the object sequence data is displayed.

18. The display processing device as set forth in claim 17, further comprising:
non-object-sequence obtaining means for obtaining the content which is different from the object sequence data,
the display control section controlling the display section to display, in the non-object-sequence display area, the content which, has been obtained by the non-object-sequence obtaining means.

19. The display processing device as set forth in claim 17, wherein:
when the display control section causes the display section to display the object sequence data in such a manner that objects contained in the object sequence are moved from a first area, in which a first number of objects are displayed per line, to a second area, in which a second number of objects, which is different from the first number of objects, are displayed per line,
the display control section causes the display section to display the object sequence data in such a manner that (i) a predetermined number of lines(s) of an object sequence starting from a second area side part in the first area is(are) moved to a first area side part in the second area and (ii) an object sequence, which follows the predetermined number of line(s) of the object sequence, is moved to the second area side part in the first area.

20. The display processing device as set forth in claim 19, wherein:
the predetermined number of line(s) is the number of line(s) in which a third number of objects are displayed, the third number of objects being a least common multiple of the first number of objects and the second number of objects.

21. The display processing device as set forth in claim 17, further comprising:
switching means for causing, in response to a predetermined trigger, the display control section to switch whether or not to provide the display avoidance area in the display area.

22. (canceled)

23. A control program by which a computer, which is included in a display processing device recited in claim 17, is operated,
said control program causing the computer to serve as the means of the display processing device.

24. A computer-readable storage medium in which a control program recited in claim 23 is stored.
